(19) United States
(12) Patent Application Publication
(10) Pub. No.: US 2026/0006567 A1
(43) Pub. Date: Jan. 1, 2026

(54) SIGNALING FOR UPLINK SYNCHRONIZATION WITH USER EQUIPMENTS

(71) Applicant: QUALCOMM Incorporated, San Diego, CA (US)

(72) Inventors: Diana MAAMARI, San Diego, CA (US); Mickael MONDET, Louannec (FR); Mostafa KHOSHNEVISAN, San Diego, CA (US); Peerapol TINNAKORNSRISUPHAP, San Diego, CA (US); Prashanth Haridas HANDE, San Diego, CA (US)

(21) Appl. No.: 18/759,263

(22) Filed: Jun. 28, 2024

(51) Int. Cl. H04W 56/00; H04W 8/22; H04W 92/18

(52) U.S. Cl. CPC H04W 56/0015; H04W 8/22; H04W 56/0045; H04W 92/18

(57) ABSTRACT

Some examples of the techniques described herein may help to ensure that uplink transmissions from two separate UEs (e.g., an anchor UE and an companion UE) reach a network within a cyclic prefix. In some approaches, a network entity may determine timing information based on signaling with an anchor UE and a companion UE. The network entity may output the timing information to the anchor UE or companion UE, which may enable the anchor UE or companion UE to synchronize transmissions to the network entity. The anchor UE may utilize the timing information to time a sidelink transmission (for relay to the network entity) and an uplink transmission (to the network entity) such that the transmissions may reach the network entity at approximately the same time (e.g., within a cyclic prefix).

### FIELD OF TECHNOLOGY

The following relates to wireless communications, including signaling for uplink synchronization with user equipments.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a first user equipment (UE) is described. The method may include receiving timing information via a downlink associated with a network entity, where the timing information is based on a propagation delay of signaling between a second UE and the network entity, transmitting, in accordance with a timing that is based on the timing information, a first signal via a sidelink between the first UE and the second UE, and transmitting a second signal via an uplink associated with the network entity, where the second signal is associated with the first signal.

A first UE is described. The first UE may include one or more processors, one or more memories coupled with the one or more processors, and one or more processor-readable instructions stored in the one or more memories and executable by the one or more processors individually or collectively operable to cause the first UE to receive timing information via a downlink associated with a network entity, where the timing information is based on a propagation delay of signaling between a second UE and the network entity, transmit, in accordance with a timing that is based on the timing information, a first signal via a sidelink between the first UE and the second UE, and transmit a second signal via an uplink associated with the network entity, where the second signal is associated with the first signal.

Another first UE is described. The first UE may include means for receiving timing information via a downlink associated with a network entity, where the timing information is based on a propagation delay of signaling between a second UE and the network entity, means for transmitting, in accordance with a timing that is based on the timing information, a first signal via a sidelink between the first UE and the second UE, and means for transmitting a second signal via an uplink associated with the network entity, where the second signal is associated with the first signal.

A non-transitory computer-readable medium storing code is described. The code may include instructions executable by one or more processors to receive timing information via a downlink associated with a network entity, where the timing information is based on a propagation delay of signaling between a second UE and the network entity, transmit, in accordance with a timing that is based on the timing information, a first signal via a sidelink between the first UE and the second UE, and transmit a second signal via an uplink associated with the network entity, where the second signal is associated with the first signal.

In some examples of the method, first UEs, and non-transitory computer-readable medium described herein, the timing information indicates a timing advance (TA) value associated with the second UE and transmitting the first signal in accordance with the timing may be based on the TA value associated with the second UE.

In some examples of the method, first UEs, and non-transitory computer-readable medium described herein, the timing information indicates a delay between a first downlink frame associated with the first UE and a second downlink frame associated with the second UE and transmitting the first signal in accordance with the timing may be based on the delay between the first downlink frame and the second downlink frame.

In some examples of the method, first UEs, and non-transitory computer-readable medium described herein, the timing information indicates a timing value of a downlink frame associated with the second UE and transmitting the first signal in accordance with the timing may be based on the timing value of the downlink frame.

Some examples of the method, first UEs, and non-transitory computer-readable medium described herein may further include operations, features, means, or instructions for determining a delay value associated with the sidelink between the first UE and the second UE, where transmitting the first signal includes transmitting the first signal via the sidelink based on the timing that may be based on the timing information and the delay value.

In some examples of the method, first UEs, and non-transitory computer-readable medium described herein, the timing information indicates a first TA value associated with the first UE and a second TA value associated with the second UE, transmitting the first signal in accordance with the timing via the sidelink may be based on the second TA value, and transmitting the second signal via the uplink may be based on the first TA value.

In some examples of the method, first UEs, and non-transitory computer-readable medium described herein, the timing information indicates a TA value associated with the first UE, a first timing value of a first downlink frame associated with the first UE, or a second timing value of a second downlink frame associated with the second UE.

Some examples of the method, first UEs, and non-transitory computer-readable medium described herein may further include operations, features, means, or instructions for determining a virtual TA value associated with the second UE based on the TA value, the first timing value of the first downlink frame associated with the first UE, and the second timing value of the second downlink frame associated with the second UE, where transmitting the first signal includes transmitting the first signal via the sidelink based on the timing that may be based on the virtual TA value.

Some examples of the method, first UEs, and non-transitory computer-readable medium described herein may further include operations, features, means, or instructions for transmitting an indicator of the virtual TA value via the sidelink associated with the second UE.

In some examples of the method, first UEs, and non-transitory computer-readable medium described herein, the virtual TA value may be based on a sum of the TA value and a difference between the second timing value and the first timing value.

Some examples of the method, first UEs, and non-transitory computer-readable medium described herein may further include operations, features, means, or instructions for transmitting, via the sidelink, the TA value associated with the first UE, the first timing value of the first downlink frame associated with the first UE, or the second timing value of the second downlink frame associated with the second UE.

Some examples of the method, first UEs, and non-transitory computer-readable medium described herein may further include operations, features, means, or instructions for transmitting capability information indicating a capability of the first UE to synchronize a transmission from the first UE and a transmission from a second UE to the network entity, where receiving the timing information may be based on the capability information.

A method by a network entity is described. The method may include obtaining signaling from a second UE via an uplink, where the second UE and a first UE are associated via a sidelink, outputting timing information via a downlink associated with the first UE, where the timing information is based on a propagation delay of the signaling, obtaining, in accordance with a timing that is based on the timing information, a first signal associated with the second UE via the uplink, and obtaining a second signal associated with the first UE via the uplink, where the second signal is associated with the first signal.

A network entity is described. The network entity may include one or more processors, one or more memories coupled with the one or more processors, and one or more processor-readable instructions stored in the one or more memories and executable by the one or more processors individually or collectively operable to cause the network entity to obtain signaling from a second UE via an uplink, where the second UE and a first UE are associated via a sidelink, output timing information via a downlink associated with the first UE, where the timing information is based on a propagation delay of the signaling, obtain, in accordance with a timing that is based on the timing information, a first signal associated with the second UE via the uplink, and obtain a second signal associated with the first UE via the uplink, where the second signal is associated with the first signal.

Another network entity is described. The network entity may include means for obtaining signaling from a second UE via an uplink, where the second UE and a first UE are associated via a sidelink, means for outputting timing information via a downlink associated with the first UE, where the timing information is based on a propagation delay of the signaling, means for obtaining, in accordance with a timing that is based on the timing information, a first signal associated with the second UE via the uplink, and means for obtaining a second signal associated with the first UE via the uplink, where the second signal is associated with the first signal.

A non-transitory computer-readable medium storing code is described. The code may include instructions executable by one or more processors to obtain signaling from a second UE via an uplink, where the second UE and a first UE are associated via a sidelink, output timing information via a downlink associated with the first UE, where the timing information is based on a propagation delay of the signaling, obtain, in accordance with a timing that is based on the timing information, a first signal associated with the second UE via the uplink, and obtain a second signal associated with the first UE via the uplink, where the second signal is associated with the first signal.

In some examples of the method, network entities, and non-transitory computer-readable medium described herein, the timing information indicates a TA value associated with the second UE and obtaining the first signal in accordance with the timing may be based on the TA value associated with the second UE.

In some examples of the method, network entities, and non-transitory computer-readable medium described herein, the timing information indicates a delay between a first downlink frame associated with the first UE and a second downlink frame associated with the second UE and obtaining the first signal in accordance with the timing may be based on the delay between the first downlink frame and the second downlink frame.

In some examples of the method, network entities, and non-transitory computer-readable medium described herein, the timing information indicates a timing value of a downlink frame associated with the second UE and obtaining the first signal in accordance with the timing may be based on the timing of the downlink frame.

In some examples of the method, network entities, and non-transitory computer-readable medium described herein, the timing information indicates a first TA value associated with the first UE and a second TA value associated with the second UE, obtaining the first signal in accordance with the timing via the uplink may be based on the second TA value, and obtaining the second signal via the uplink may be based on the first TA value.

In some examples of the method, network entities, and non-transitory computer-readable medium described herein, the timing information indicates a TA value associated with the first UE, a first timing value of a first downlink frame associated with the first UE, or a second timing value of a second downlink frame associated with the second UE.

Some examples of the method, network entities, and non-transitory computer-readable medium described herein may further include operations, features, means, or instructions for obtaining capability information indicating a capability of the first UE to synchronize a transmission from the first UE and a transmission from a second UE to the network entity, where outputting the timing information may be based on the capability information.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports signaling for uplink synchronization with user equipments (UEs) in accordance with one or more aspects of the present disclosure.

FIG. 2 shows an example of a wireless communications system that supports signaling for uplink synchronization with UEs in accordance with one or more aspects of the present disclosure.

FIG. 3 shows an example of a timing diagram that supports signaling for uplink synchronization with UEs in accordance with one or more aspects of the present disclosure.

FIG. 4 shows an example of a timing diagram that supports signaling for uplink synchronization with UEs in accordance with one or more aspects of the present disclosure.

FIG. 5 shows an example of a process flow that supports signaling for uplink synchronization with UEs in accordance with one or more aspects of the present disclosure.

FIGS. 6 and 7 show block diagrams of devices that support signaling for uplink synchronization with UEs in accordance with one or more aspects of the present disclosure.

FIG. 8 shows a block diagram of a communications manager that supports signaling for uplink synchronization with UEs in accordance with one or more aspects of the present disclosure.

FIG. 9 shows a diagram of a system including a device that supports signaling for uplink synchronization with UEs in accordance with one or more aspects of the present disclosure.

FIGS. 10 and 11 show block diagrams of devices that support signaling for uplink synchronization with UEs in accordance with one or more aspects of the present disclosure.

FIG. 12 shows a block diagram of a communications manager that supports signaling for uplink synchronization with UEs in accordance with one or more aspects of the present disclosure.

FIG. 13 shows a diagram of a system including a device that supports signaling for uplink synchronization with UEs in accordance with one or more aspects of the present disclosure.

FIGS. 14 through 17 show flowcharts illustrating methods that support signaling for uplink synchronization with UEs in accordance with one or more aspects of the present disclosure.

### DETAILED DESCRIPTION

Some devices may communicate using wireless signaling via one or more antennas. Some devices (e.g., some extended reality (XR) devices) may have a relatively small form factor with limited size that may constrain a quantity of antennas. For example, some devices such as smartphones may accommodate four antennas, while some augmented reality (AR) devices or wearable devices such as watches may have fewer than four antennas for signaling in some frequency bands. For instance, AR glasses may be limited to two receive antennas, or a watch may be limited to one receive antenna in some cases. Even in a case of two receive antennas on AR glasses, the antenna correlation factor may be relatively high, which may limit multiple-input-multiple-output (MIMO) rank gains.

In some approaches, multiple devices may cooperate to achieve gains that may be otherwise be limited due to constraints on a quantity of antennas. For example, two or more user equipments (UEs) (e.g., an “anchor UE” and a “companion UE”) may cooperatively group antennas for communications with a network entity. In some aspects, multiple UEs with a user or near a user may be utilized, such as a watch, battery pack, smartphone, tablet device, laptop computer, virtual reality (VR) headset, or AR glasses, among other examples. An anchor UE may be a UE that is a data source for communication or a data sink (e.g., target) for communication. A companion UE may be a UE that functions to forward or relay signals or data between an anchor UE and a network entity (e.g., to forward data from the anchor UE to the network entity, to forward data from the network entity to the anchor UE, or a combination of both).

In some examples, two UEs (e.g., an anchor UE and a companion UE) may cooperate to increase spatial multiplexing capability, which may achieve significant gains in system throughput (and user-perceived throughput). In some approaches, an anchor UE may cooperate with a companion UE for load balancing. Additionally, or alternatively, one or more companion UEs may be aggregated with an anchor UE into a virtual UE for load balancing or to increase MIMO gains. For instance, AR glasses or a wearable device may have one or two antennas, where a virtual UE may be formed with four or more antennas through cooperation with a companion UE.

In some examples, a sidelink may be established between a companion UE and an anchor UE. A sidelink may be a wired or wireless link between UEs. For instance, a sidelink may be established as a universal serial bus (USB) link, a Third Generation Partnership Project (3GPP) sidelink, a non-3GPP sidelink, a new radio (NR) sidelink, a vehicle-to-everything (V2X) (e.g., PC5) link, an ultra-wideband (UWB) link, a Bluetooth link, or a Wi-Fi link, among other examples. In some aspects, the sidelink may provide a relatively low-power, relatively high bandwidth, relatively low latency, or relatively high reliability cooperative link between the companion UE and the anchor UE.

In some examples, an anchor UE and a companion UE may have similar capabilities. For instance, an anchor UE and a companion UE may both have processing capabilities for one or more layers of a protocol stack. For instance, a “full stack” of processing capabilities for a Uu interface may include processing capabilities for a service data adaptation protocol (SDAP) layer, a packet data convergence protocol (PDCP) layer, a radio link control (RLC) layer, a medium access control (MAC) layer, and a physical (PHY) layer. A full stack of processing capability may enable a UE to perform processing functions for establishing and controlling a link with a network entity. In some examples where an anchor UE and a companion UE have similar (e.g., full stack) capabilities, the companion UE may function as a layer 3 multi-path relay. For instance, the companion UE may forward data to or from the anchor UE at layer 3 (e.g., a radio resource control (RRC) layer) or above. In some aspects, an anchor UE and a companion UE may each include a sidelink modem, one or more antennas (e.g., cellular antennas), or partial or full stack processing capability.

In some examples, an anchor UE and a companion UE may have differing capabilities (e.g., the companion UE may have lesser capability than the anchor UE). For instance, an anchor UE may have full stack processing capability, while a companion UE may function as an external antenna panel (e.g., a remote radio head (RRH)) for forwarding in-phase or quadrature (IQ) samples. In some aspects, baseband processing (e.g., baseband processing for a Uu link) may be performed at the anchor UE, where the anchor UE implements a full stack for a protocol. Data processing of a higher layer(s) (e.g., SDAP, PDCP, RLC, or MAC) may be performed at the anchor UE. The companion UE may function as an external radio frequency (RF) antenna panel, where IQ samples may be forwarded via a sidelink from the companion UE to the anchor UE as a first signal. For instance, the anchor UE may provide SDAP, PDCP, RLC, MAC, or PHY processing to provide IQ samples to a sidelink modem (e.g., a 3GPP sidelink modem or a non-3GPP sidelink modem), which may transmit a first signal representing the IQ samples to the companion UE via a sidelink. A sidelink modem (e.g., 3GPP or non-3GPP sidelink modem) of the companion UE may receive the first signal and provide the IQ samples to an RF component, which may transmit (e.g., forward) the IQ samples to a network entity. Forwarding IQ samples between the network entity and the anchor UE (via the companion UE) may demand a relatively high bandwidth and relatively low latency on the sidelink. In some examples, forwarded data and channel state feedback (CSF) may have matching precoding. One or more of the approaches described herein may inherently allow one quality of service (QoS) or service data flow (SDF) to be mapped to two connections.

The network entity may implement a full stack (e.g., SDAP, PDCP, RLC, MAC, PHY) of a protocol (e.g., a protocol for a Uu link or other link). For instance, the network entity may receive the IQ samples corresponding to the first signal. The anchor UE may also transmit a second signal directly to the network entity (e.g., without the second signal being forwarded or relayed).

In some cases, cooperating devices may experience different propagation or signaling delays that may cause signaling from different devices to arrive at different times at a network. For instance, signaling from AR glasses may arrive at a network entity before signaling from a cooperating UE. In some approaches where IQ samples are forwarded between devices, the transmissions from two UEs may fail to reach the network entity within a cyclic prefix (CP), which may be demanded for PHY layer cooperation if one physical uplink shared channel (PUSCH) is transmitted.

Some examples of the techniques described herein may help to ensure that uplink transmissions from two separate UEs (e.g., an anchor UE and an companion UE) reach the network within a CP (e.g., at approximately the same time) at the network. In some approaches, each UE may transmit using a respective Timing Advance (TA) (e.g., TA1 and TA2). However, challenges may arise in contexts where a companion UE is an RRH, which may provide antennas with relatively little or no additional processing capability. If there is a single TA reference to the anchor UE, the anchor UE may determine how to compensate the TA at the companion UE such that the companion UE transmission reaches the network at approximately the same time as the anchor UE transmission. In the case that two TAs are used, the delay of the cooperative link or sidelink may be compensated to avoid slowing the arrival of the IQ samples such that TA is no longer valid. Accordingly, some of the techniques described herein may provide approaches for synchronizing transmissions between cooperating UEs. For instance, some of the techniques described herein may help to ensure that the samples from different UEs arrive within a valid TA from a start of the transmission.

In some approaches, a network entity may determine timing information (e.g., one or more TAs, time differences between downlink frames, or other timing information) based on signaling with an anchor UE and a companion UE. The network entity may output (e.g., transmit) the timing information to the anchor UE or companion UE, which may enable the anchor UE or companion UE to synchronize transmissions to the network entity. For instance, the network entity may determine a TA value associated with the companion UE, which the network entity may output to the anchor UE. The anchor UE may utilize the timing information to time a sidelink transmission (for relay to the network entity) and an uplink transmission (to the network entity) such that the transmissions may reach the network entity at approximately the same time (e.g., within a CP).

Aspects of the disclosure are initially described in the context of wireless communications systems. Aspects of the disclosure are also described in the context of timing diagrams. Aspects of the disclosure are further described in the context of a process flow. Aspects of the disclosure are further illustrated by and described with reference to apparatus diagrams, system diagrams, and flowcharts that relate to signaling for uplink synchronization with UEs.

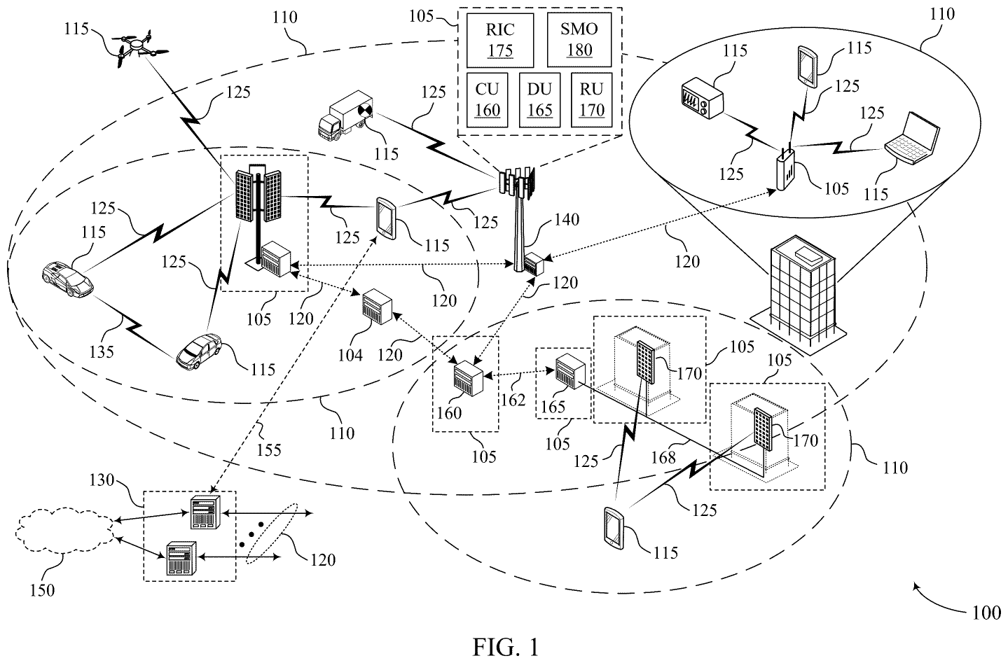

FIG. 1 shows an example of a wireless communications system 100 that supports signaling for uplink synchronization with UEs in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ns may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some devices may communicate using wireless signaling via one or more antennas. Some devices (e.g., some XR devices) may have a relatively small form factor with limited size that may constrain a quantity of antennas. For example, some devices such as smartphones may accommodate four antennas, while some AR devices or wearable devices such as watches may have fewer than four antennas for signaling in some frequency bands. For instance, AR glasses may be limited to two receive antennas, or a watch may be limited to one receive antenna in some cases. Even in a case of two receive antennas on AR glasses, the antenna correlation factor may be relatively high, which may limit MIMO rank gains.

In some approaches, multiple devices may cooperate to achieve gains that may be otherwise be limited due to constraints on a quantity of antennas. For example, two or more UEs 115 (e.g., an anchor UE 115 and a companion UE 115) may cooperatively group antennas for communications with a network entity 105. In some aspects, multiple UEs 115 with a user or near a user may be utilized, such as a watch, battery pack, smartphone, tablet device, laptop computer, VR headset, or AR glasses, among other examples. An anchor UE 115 may be a UE 115 that is a data source for communication or a data sink (e.g., target) for communication. A companion UE 115 may be a UE 115 that functions to forward or relay signals or data between an anchor UE 115 and a network entity 105 (e.g., to forward data from the anchor UE 115 to the network entity 105, to forward data from the network entity 105 to the anchor UE 115, or a combination of both).

In some examples, two UEs 115 (e.g., an anchor UE 115 and a companion UE 115) may cooperate to increase spatial multiplexing capability, which may achieve significant gains in system throughput (and user-perceived throughput). In some approaches, an anchor UE 115 may cooperate with a companion UE 115 for load balancing. Additionally, or alternatively, one or more companion UEs 115 may be aggregated with an anchor UE 115 into a virtual UE for load balancing or to increase MIMO gains. For instance, AR glasses or a wearable device may have one or two antennas, where a virtual UE may be formed with four or more antennas through cooperation with a companion UE 115.

In some examples, a sidelink may be established between a companion UE 115 and an anchor UE 115. A sidelink (e.g., a D2D communication link 135) may be a wired or wireless link between UEs 115. For instance, a sidelink may be established as a USB link, a 3GPP sidelink, a non-3GPP sidelink, an NR sidelink, a V2X (e.g., PC5) link, a UWB link, a Bluetooth link, or a Wi-Fi link, among other examples. In some aspects, the sidelink may provide a relatively low-power, relatively high bandwidth, relatively low latency, or relatively high reliability cooperative link between the companion UE 115 and the anchor UE 115.

In some examples, an anchor UE 115 and a companion UE 115 may have similar capabilities. For instance, an anchor UE 115 and a companion UE 115 may both have processing capabilities for one or more layers of a protocol stack. For instance, a full stack of processing capabilities for a Uu interface may include processing capabilities for an SDAP layer, a PDCP layer, a RLC layer, a MAC layer, and a PHY layer. A full stack of processing capability may enable a UE 115 to perform processing functions for establishing and controlling a link with a network entity 105. In some examples where an anchor UE 115 and a companion UE 115 have similar (e.g., full stack) capabilities, the companion UE 115 may function as a layer 3 multi-path relay. For instance, the companion UE 115 may forward data to or from the anchor UE 115 at layer 3 (e.g., an RRC layer) or above. In some aspects, an anchor UE 115 and a companion UE 115 may each include a sidelink modem, one or more antennas (e.g., cellular antennas), or partial or full stack processing capability.

In some examples, an anchor UE 115 and a companion UE 115 may have differing capabilities (e.g., the companion UE 115 may have lesser capability than the anchor UE 115). For instance, an anchor UE 115 may have full stack processing capability, while a companion UE 115 may function as an external antenna panel (e.g., an RRH) for forwarding IQ samples. In some aspects, baseband processing (e.g., baseband processing for a Uu link) may be performed at the anchor UE 115, where the anchor UE 115 implements a full stack for a protocol. Data processing of a higher layer(s) (e.g., SDAP, PDCP, RLC, or MAC) may be performed at the anchor UE 115. The companion UE 115 may function as an external RF antenna panel, where IQ samples may be forwarded via a sidelink from the companion UE 115 to the anchor UE 115 as a first signal. For instance, the anchor UE 115 may provide SDAP, PDCP, RLC, MAC, or PHY processing to provide IQ samples to a sidelink modem (e.g., a 3GPP sidelink modem or a non-3GPP sidelink modem), which may transmit a first signal representing the IQ samples to the companion UE 115 via a sidelink. A sidelink modem (e.g., 3GPP or non-3GPP sidelink modem) of the companion UE 115 may receive the first signal and provide the IQ samples to an RF component, which may transmit (e.g., forward) the IQ samples to a network entity 105. Forwarding IQ samples between the network entity 105 and the anchor UE 115 (via the companion UE 115) may demand a relatively high bandwidth and relatively low latency on the sidelink. In some examples, forwarded data and CSF may have matching precoding. One or more of the approaches described herein may inherently allow one QoS or SDF to be mapped to two connections.

The network entity 105 may implement a full stack (e.g., SDAP, PDCP, RLC, MAC, PHY) of a protocol (e.g., a protocol for a Uu link or other link). For instance, the network entity 105 may receive the IQ samples corresponding to the first signal. The anchor UE 115 may also transmit a second signal directly to the network entity 105 (e.g., without the second signal being forwarded or relayed).

In some cases, cooperating devices may experience different propagation or signaling delays that may cause signaling from different devices to arrive at different times at a network. For instance, signaling from AR glasses may arrive at a network entity 105 before signaling from a cooperating UE 115. In some approaches where IQ samples are forwarded between devices, the transmissions from two UEs 115 may fail to reach the network entity 105 within a CP, which may be demanded for PHY layer cooperation if one PUSCH is transmitted.

Some examples of the techniques described herein may help to ensure that uplink transmissions from two separate UEs 115 (e.g., an anchor UE 115 and an companion UE 115) reach the network within a CP (e.g., at approximately the same time) at the network. In some approaches, each UE 115 may transmit using a respective TA (e.g., TA1 and TA2). However, challenges may arise in contexts where a companion UE 115 is an RRH, which may provide antennas with relatively little or no additional processing capability. If there is a single TA reference to the anchor UE 115, the anchor UE 115 may determine how to compensate the TA at the companion UE 115 such that the companion UE 115 transmission reaches the network at approximately the same time as the anchor UE 115 transmission. In the case that two TAs are used, the delay of the cooperative link or sidelink may be compensated to avoid slowing the arrival of the IQ samples such that TA is no longer valid. Accordingly, some of the techniques described herein may provide approaches for synchronizing transmissions between cooperating UEs 115 with IQ forwarding. For instance, some of the techniques described herein may help to ensure that the samples from different UEs 115 arrive within a valid TA from a start of the transmission.

In some approaches, a network entity 105 may determine timing information (e.g., one or more TAs, time differences between downlink frames, or other timing information) based on signaling with an anchor UE 115 and a companion UE 115. The network entity 105 may output (e.g., transmit) the timing information to the anchor UE 115 or companion UE 115, which may enable the anchor UE 115 or companion UE 115 to synchronize transmissions to the network entity 105. For instance, the network entity 105 may determine a TA value associated with the companion UE 115, which the network entity 105 may output to the anchor UE 115. The anchor UE 115 may utilize the timing information to time a sidelink transmission (for relay to the network entity 105) and an uplink transmission (to the network entity 105) such that the transmissions may reach the network entity 105 at approximately the same time (e.g., within a CP).

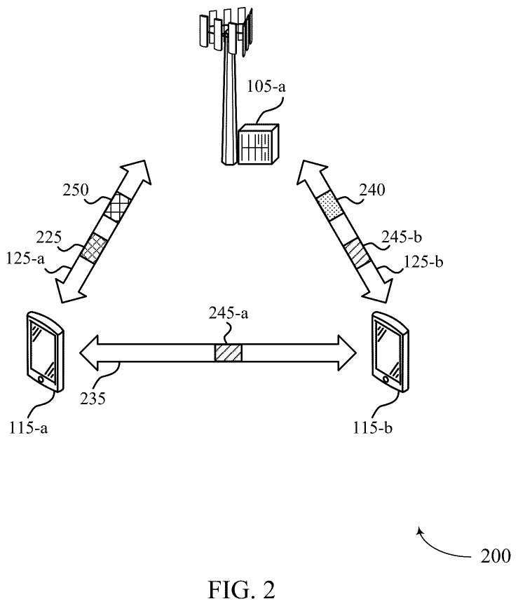

FIG. 2 shows an example of a wireless communications system 200 that supports signaling for uplink synchronization with UEs in accordance with one or more aspects of the present disclosure. The wireless communications system 200 may implement aspects of or may be implemented by aspects of the wireless communications system 100. For example, the wireless communications system 200 includes a first UE 115-a and a second UE 115-b, which may examples of the UE 115 described with reference to FIG. 1. The wireless communications system 200 also includes a network entity 105-a, which may be an example of a network entity 105 as described with reference to FIG. 1.

The first UE 115-a and the second UE 115-b may be associated via a sidelink 235. For example, the first UE 115-a may communicate with the second UE 115-b via the sidelink 235. As used herein, the term “communicate” and variations thereof may include signal transmission, signal reception, or a combination thereof. The sidelink 235 may be a communication link between the first UE 115-a and the second UE 115-b (without an intervening device, for instance). The sidelink 235 may be established to provide bidirectional communications between the first UE 115-a and the second UE 115-b. For example, the sidelink 235 may carry one or more signals from the first UE 115-a to the second UE 115-b or one or more signals from the second UE 115-b to the first UE 115-a. For instance, one or more signals communicated between the first UE 115-a and the second UE 115-b may include one or more control signals or one or more data signals. In some aspects, the D2D communication link 135 described with reference to FIG. 1 may be an example of the sidelink 235. Examples of the sidelink 235 may include a USB link, a 3GPP sidelink (where a signal may be carried via a physical sidelink control channel (PSCCH), a physical sidelink shared channel (PSSCH), or a physical sidelink broadcast channel (PSBCH), among other examples), a non-3GPP sidelink, an NR sidelink, a V2X (e.g., PC5) link, a UWB link, a Bluetooth link, or a Wi-Fi link.

The first UE 115-a may communicate with the network entity 105-a using a communication link 125-a, which may be an example of a communication link 125 described with reference to FIG. 1. The communication link 125-a may include a uni-directional or bi-directional link that enables uplink or downlink network communications. For example, the first UE 115-a may transmit uplink network transmissions, such as uplink control signals or uplink data signals, to the network entity 105-a using the communication link 125-a, or the network entity 105-a may transmit downlink network transmissions, such as downlink control signals or downlink data signals, to the first UE 115-a using the communication link 125-a.

The second UE 115-b may communicate with the network entity 105-a using a communication link 125-b, which may be an example of a communication link 125 described with reference to FIG. 1. The communication link 125-b may include a uni-directional or bi-directional link that enables uplink or downlink network communications. For example, the second UE 115-b may transmit uplink network transmissions, such as uplink control signals or uplink data signals, to the network entity 105-a using the communication link 125-b, or the network entity 105-a may transmit downlink network transmissions, such as downlink control signals or downlink data signals, to the second UE 115-b using the communication link 125-b.

In some examples, the sidelink 235 may operate with or without the communication link 125-a or the communication link 125-b (e.g., may operate independently from the communication link 125-a, may operate independently from the communication link 125-b or may operate in conjunction with the communication link 125-a). In some cases, the second UE 115-b may relay one or more downlink signals from the network entity 105-a to the first UE 115-a via the sidelink 235 or may relay one or more uplink signals from the first UE 115-a to the network entity 105-a via the communication link 125-b.

In some aspects, the first UE 115-a may be an anchor UE and the second UE 115-b may be a companion UE. Additionally, or alternatively, the first UE 115-a may be a companion UE and the second UE 115-b may be an anchor UE. The first UE 115-a and the second UE 115-b may have similar capabilities (e.g., full stack processing capabilities) in some examples, or the first UE 115-a and the second UE 115-b may have differing capabilities (e.g., the anchor UE may have full stack processing capabilities and the companion UE may have less than full stack processing capabilities) in some examples.

The network entity 105-a may output, or the first UE 115-a may receive, timing information 225 via a downlink (of the communication link 125-a, for instance) associated with the network entity 105-a. The timing information 225 may be based on a propagation delay of signaling 240 between a second UE 115-b and the network entity 105-a. For example, the propagation delay of signaling 240 between the second UE 115-b and the network entity 105-a may be an amount of time for a signal to travel from the second UE 115-b to the network entity 105-a or from the network entity 105-a to the UE 115-b. For instance, the second UE 115-b may transmit, or the network entity 105-a may obtain, the signaling 240 via an uplink (e.g., an uplink of the communication link 125-b), where the propagation delay may be based on (e.g., may be determined or estimated by the network entity 105-a based on) the signaling 240. In some examples, a propagation delay associated with a companion UE may be denoted d_{C} or a propagation delay associated with an anchor UE may be denoted d_{A}.

In some approaches, the network entity 105-a may determine (e.g., estimate) the propagation delay or a quantity that is based on the propagation delay. Examples of quantities that are based on the propagation delay may include a TA value associated with the second UE 115-b (e.g., TA_{C} for a companion UE or TA_{A} for an anchor UE), a timing value of a downlink frame associated with the second UE 115-b, or a delay between a first downlink frame associated with the first UE 115-a and a second downlink frame associated with the second UE 115-b, among other examples. In some aspects, the timing information 225 may indicate or may be based on the propagation delay or may be based on a quantity that is based on the propagation delay. The timing information 225 may be communicated to help ensure uplink synchronization between uplink signaling of the first UE 115-a and the second UE 115-b. For instance, one or more kinds of timing information 225 may be communicated to the first UE 115-a to approximately synchronize an arrival time of uplink signaling of the first UE 115-a and the second UE 115-b at the network entity 105-a.

The first UE 115-a may communicate a first signal 245-a via the sidelink 235 between the first UE and the second UE 115-b. The first signal 245-a may be a data signal or a control signal. In some examples, the first signal 245-a may be represented as one or more IQ samples. The second UE 115-b may receive the first signal 245-a. The second UE 115-b may transmit (e.g., relay or forward), or the network entity 105-a may obtain, the first signal 245-b. For instance, the second UE 115-b may transmit, or the network entity 105-a may obtain, the first signal 245-b, where the first signal 245-b is associated with the second UE 115-b via the uplink.

The first UE 115-a may transmit, or the network entity 105-a may obtain (e.g., receive), a second signal 250 via an uplink (e.g., an uplink of the communication link 125-a) associated with the network entity 105-a. The second signal 250 may be associated with (e.g., transmitted from) the first UE 115-a.

The second signal 250 may be associated with the first signal 245-a or the first signal 245-b. In some examples, the second signal 250 may be similar to (e.g., may include the same data or control information as) the first signal 245-a or the first signal 245-b. For instance, the first signal 245-a or the first signal 245-b may be similar to the second signal 250 to provide diversity gain, which may provide a greater probability for the network entity 105-a to successfully receive the content (e.g., data or control information) of the first signal 245-b or the second signal 250. For example, the first signal 245-b and the second signal 250 may be associated as copies of a signal transmitted from different antennas for diversity gain.

In some examples, the second signal 250 may be different from (e.g., may include different data or control information from) the first signal 245-a or the first signal 245-b. For instance, the first signal 245-a or the first signal 245-b may be different from the second signal 250 to provide one or more additional transmission layers, which may provide greater throughput (e.g., data or control information of the first signal 245-b in addition to data or control information of the second signal 250) to the network entity 105-a. In some aspects, the first signal 245-b may provide one or more spatial layers or spatial streams in addition to one or more spatial layers or spatial streams associated with the second signal 250. For instance, the first signal 245-b and the second signal 250 may be associated as different layers or streams of a MIMO transmission.

The first signal 245-a or the first signal 245-b may be communicated (e.g., transmitted, output, received, or obtained) in accordance with a timing that is based on the timing information 225. For example, the timing may approximately synchronize a time at which the first signal 245-a is obtained (e.g., received) at the network entity 105-a with a time at which the second signal 250 is obtained (e.g., received) at the network entity 105-a.

In some aspects, the timing may be expressed or implemented as a difference in time between a transmission time of the first signal 245-a (or the first signal 245-b) and a transmission time of the second signal 250. For instance, the first signal 245-a may be transmitted before the second signal 250 to account for one or more delays (e.g., a delay value associated with the sidelink 235, a delay to process or retransmit the first signal 245-a at the second UE 115-b, the propagation delay between the second UE 115-b and the network entity 105-a, or one or more other delays).

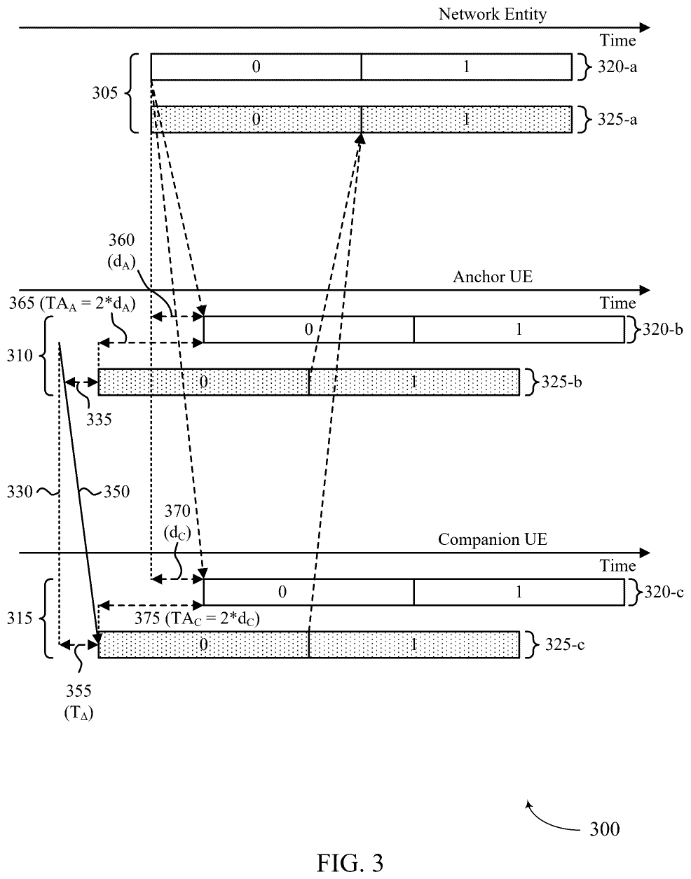

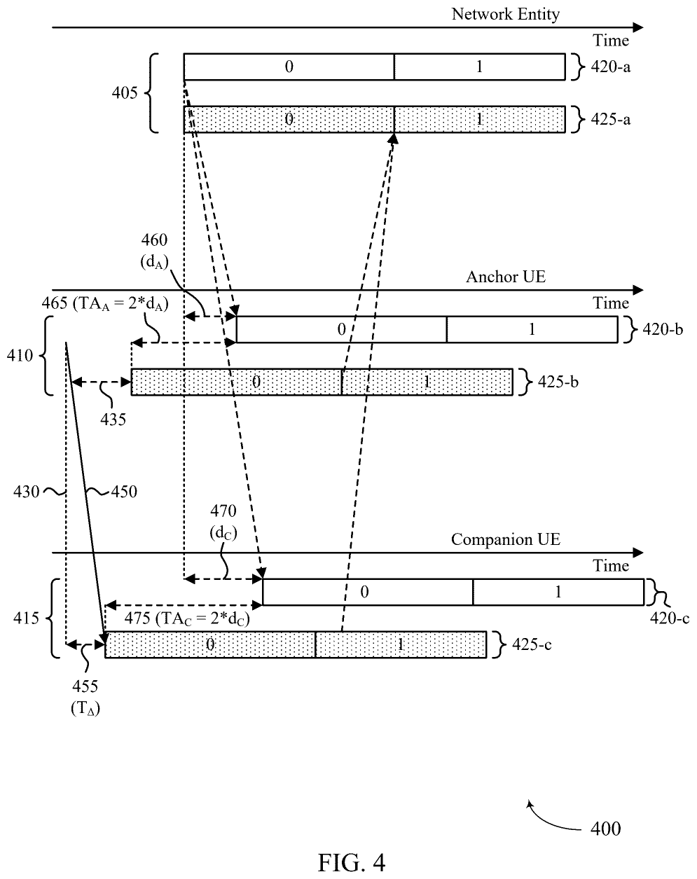

In some examples, the timing information 225 may indicate a TA value (e.g., TA2 or TA_{C}) associated with the second UE 115-b. Transmitting, outputting, receiving, or obtaining the first signal 245-a or the first signal 245-b in accordance with the timing may be based on the TA value associated with the second UE 115-b. For instance, the TA value may be utilized to advance a time at which the first signal 245-a or the first signal 245-b is transmitted (e.g., to transmit the first signal 245-a or the first signal 245-b sooner) to reduce a timing difference (e.g., synchronization error between the first signal 245-b and a frame time of the network entity 105-a) or to compensate for the propagation delay. In some examples, the timing information 225 may indicate a timing value of a start of a downlink frame (e.g., a downlink frame associated with the second UE 115-b or a companion UE's downlink frame) plus a TA value associated with the second UE 115-b (e.g., TA2 or TA_{C}). Transmitting or obtaining (e.g., receiving) the first signal 245-a or the first signal 245-b in accordance with the timing may be based on the timing value of the downlink frame. For instance, the timing value of the downlink frame+TA_{C} may be utilized to synchronize the first signal 245-b and the second signal 250. Examples of TA_{C} are provided with reference to FIG. 3 and FIG. 4.

In some approaches, the network entity 105-a may determine (e.g., estimate) the TA value (e.g., TA2 or TA_{C}) associated with the second UE 115-b. The TA value may be based on the propagation delay (e.g., may be two times the propagation delay or may be a quantized value that approximates the propagation delay or a value based on the propagation delay). In some aspects, the TA value may be determined based on the signaling 240. For instance, the network entity 105 may receive the signaling 240, where a frame time or a slot time (e.g., for an uplink frame) of the signaling 240 differs from a frame time or slot time (e.g., for a downlink frame) at the network entity 105-a. In some approaches, the propagation delay or a TA value may be determined (e.g., estimated) as a difference between a frame time of an uplink frame (e.g., uplink frame i) and a frame time of a downlink frame (e.g., downlink frame i). Additionally, or alternatively, the signaling 240 may include a time indicator that indicates when the signaling 240 was transmitted. The network entity 105-a may compare the transmission time of the signaling 240 to a reception time of the signaling 240 to determine (e.g., estimate) the propagation delay or TA value between the second UE 115-b and the network entity 105-a.

In some examples, the network entity 105-a may determine (e.g., estimate) a round trip time (RTT) associated with the propagation delay or the TA value (e.g., transmit timing for the communication link 125-b). An RTT may be an amount of time that is approximately double the propagation delay. For instance, the propagation delay=RTT/2. In some approaches, the network entity 105-a may estimate the RTT and may provide the timing information 225 as the TA value or an uplink TA command to the first UE 115-a or to the second UE 115-b. In some approaches, an uplink transmit timing=downlink receive timing-TA. The first UE 115-a or the second UE 115-b may track downlink timing and may adjust uplink transmit timing to approximately synchronize the uplink transmit timing with the downlink receive timing.

In some aspects, the signaling 240 may be (or may include) a preamble or a physical random access channel (PRACH). The network entity 105-a may determine (e.g., estimate) the RTT from the preamble or PRACH and may provide the TA value in a random access response (RAR) to the first UE 115-a or to the second UE 115-b. For instance, the timing information 225 may be included in a TA command or a RAR in some approaches. One or more subsequent updates of the TA may be performed via one or more reference signal measurements (e.g., a measurement(s) of a sounding reference signal (SRS) or of a demodulation reference signal (DMRS)). After an initial RACH, for instance, the network entity 105-a may utilize an uplink SRS, DMRS, or other reference signal to estimate the TA value and provide the TA value to the first UE 115-a or to the second UE 115-b. In some examples, the TA value may be updated via a medium access control-control element (MAC-CE). For instance, the timing information 225 may be included in a MAC-CE in some approaches. In some aspects, the timing information 225 (e.g., TA value) may be provided to the first UE 115-a via a TA command, RAR, MAC-CE, or a combination thereof (e.g., a TA command MAC-CE) associated with the second UE 115-b.

In some examples, a TA command MAC-CE may be identified by a MAC subheader with a logical channel identifier (LCID). In some examples, the TA command MAC-CE may have a fixed size (e.g., an octet). The TA command MAC-CE may include a timing advance group identifier (TAG ID) field (e.g., a two-bit field), which may indicate a TAG ID for a timing access group (TAG) that includes the second UE 115-b. The TA command MAC-CE may include a TA command field (e.g., a six-bit field), which may indicate the TA value. For instance, the TA value may be expressed as an index value (0, 1, 2, . . . , 63) that may be utilized to control an amount of timing adjustment that a UE (e.g., the first UE 115-a, the second UE 115-b, or a MAC entity) may apply.

In some approaches, the first UE 115-a (e.g., an anchor UE) and the second UE 115-b (e.g., a companion UE) may be configured with separate TAs (e.g., TA1 or TA_{A} and TA2 or TA_{C}), and the first UE 115-a may transmit IQ samples as the first signal 245-a to the second UE 115-b (e.g., no encoding may be performed at the second UE 115-b or the companion UE). In some examples, separate TAs may be utilized in a scenario where the second UE 115-b (e.g., companion UE) includes a full stack protocol processing capability, but the stack is being split at the PHY layer (e.g., to provide cooperation in the low PHY layer for realizing MIMO or beamforming gains).

In some examples, the timing information 225 may indicate a delay between a first downlink frame associated with the first UE 115-a and a second downlink frame associated with the second UE 115-b. For instance, the timing information 225 may indicate a delay between the first downlink frame (e.g., an anchor UE's downlink frame) and the second downlink frame (e.g., a companion UE's downlink frame) plus the propagation delay associated with the second UE 115-b (e.g., the propagation delay experienced by the second UE 115-b or d_{C}). Examples of the propagation delay associated with the second UE 115-b (e.g., d_{C}) are provided with reference to FIG. 3 and FIG. 4. Transmitting or obtaining (e.g., receiving) the first signal 245-a or the first signal 245-b in accordance with the timing may be based on the delay between the first downlink frame and the second downlink frame. For instance, the delay between the first downlink frame and the second downlink frame+d_{C} may be utilized to synchronize the first signal 245-b and the second signal 250.

In some examples, the timing information 225 may indicate a timing value of a downlink frame associated with the second UE 115-b. For instance, the timing information 225 may indicate a timing value of a start of a downlink frame (e.g., a companion UE's downlink frame) plus the propagation delay associated with the second UE 115-b (e.g., the propagation delay experienced by the second UE 115-b or d_{C}). Transmitting or obtaining (e.g., receiving) the first signal 245-a or the first signal 245-b in accordance with the timing may be based on the timing value of the downlink frame. For instance, the timing value of the downlink frame+d_{C} may be utilized to synchronize the first signal 245-b and the second signal 250.

In some examples, the first UE 115-a may determine a delay value (e.g., T_{Δ}) associated with the sidelink 235 between the first UE 115-a and the second UE 115-b. For instance, the first UE 115-a (e.g., an anchor UE) or the second UE 115-b (e.g., a companion UE) may negotiate or estimate the delay value (e.g., T_{Δ}) on the sidelink 235 (e.g., a 3GPP link or non-3GPP link). The delay value (e.g., T_{Δ}) may depend on one or more channel conditions, sidelink (e.g., cooperation link) type, congestion level, or a mobility of the first UE 115-a or the second UE 115-b (e.g., a user with XR wearables), among other examples.

In some approaches, the delay value (e.g., T_{Δ}) may be indicated via downlink signaling (e.g., timing information 225) from the network entity 105-a to the first UE 115-a. For example, downlink signaling may be utilized to convey cross-UE information, the delay value may be estimated or negotiated between the first UE 115-a and the second UE 115-b, or a synchronization signal with one or more of the quantities described herein (e.g., a delay between downlink frames, a timing value of one or more downlink frames, d_{C}, d_{A}, one or more TA values, TA_{C}, TA_{A}, a delay value, or T_{Δ} among other examples) may be signaled to the first UE 115-a. For instance, the second UE 115-b may determine (e.g., estimate) the delay value (e.g., T_{Δ}), which may be indicated to the network entity 105-a, which may indicate the delay value to the first UE 115-a. Additionally, or alternatively, the network entity 105-a may determine (e.g., estimate) the delay value (e.g., T_{Δ}) and indicate the delay value to the first UE 115-a. For instance, the network entity 105-a may utilize a timestamp of a signal relayed from the first UE 115-a via the second UE 115-b to estimate a total delay from the first UE 115-a to the network entity 105-a via the second UE 115-b, and may subtract the propagation delay from the total delay to determine the delay value (e.g., T_{Δ}), which may be indicated to the first UE 115-a via downlink signaling.

In some examples, the first UE 115-a may transmit the first signal 245-a by transmitting the first signal 245-a via the sidelink 235 based on the timing that is based on the timing information 225 and the delay value. In some approaches, if one or more samples are received after TA_{C}, the second UE 115-b (e.g., a companion UE) may determine that the samples are received in error or may discard the one or more samples.

In some approaches, the timing information 225 may indicate a first TA value (e.g., TA1 or TA_{A}) associated with the first UE 115-a and a second TA value (e.g., TA2 or TA_{C}) associated with the second UE 115-b. Transmitting or obtaining the first signal 245-a in accordance with the timing via the sidelink 235 may be based on the second TA value, and transmitting the second signal 250 via the uplink may be based on the first TA value.

In some examples, one or more of the signals described herein (e.g., the timing information 225) may notify the first UE 115-a (e.g., an anchor UE) of the start of an uplink frame of the second UE 115-b (e.g., a companion UE). The first UE 115-a may utilize one or more of the signals described (e.g., the timing information 225) to determine when to transmit the first signal 245-a (e.g., IQ samples) to the second UE 115-b.

In some approaches, the first UE 115-a (e.g., an anchor UE) and the second UE 115-b (e.g., a companion UE) may be configured with separate TAs (e.g., TA1 and TA2), and the second UE 115-b may transmit IQ samples (e.g., IQ samples as the first signal 245-b to the network entity 105-a). For example, second timing information (not shown in FIG. 2) may be communicated to the second UE 115-b to help ensure uplink synchronization between uplink signaling of the first UE 115-a and the second UE 115-b. For instance, one or more of the signals described herein (e.g., second timing information that may be similar to the timing information 225) may be utilized to notify the second UE 115-b (e.g., a companion UE) of one or more values described herein for uplink synchronization. The second timing information may be communicated via the sidelink 235, the communication link 125-b (e.g., a downlink from the network entity 105-a), or a combination of both.

In some examples, the second timing information may indicate a delay between a first downlink frame associated with the first UE 115-a and a second downlink frame associated with the second UE 115-b. For instance, the second timing information may indicate a delay between the first downlink frame (e.g., an anchor UE's downlink frame) and the second downlink frame (e.g., a companion UE's downlink frame) plus the propagation delay associated with the first UE 115-a (e.g., the propagation delay experienced by the first UE 115-a or d_{A}). Examples of the propagation delay associated with the first UE 115-a (e.g., d_{A}) are provided with reference to FIG. 3 and FIG. 4. Communicating (e.g., receiving or transmitting) the first signal 245-a or the first signal 245-b in accordance with the timing may be based on the delay between the first downlink frame and the second downlink frame. For instance, the delay between the first downlink frame and the second downlink frame+d_{A} may be utilized to synchronize the first signal 245-b and the second signal 250.

In some examples, the second timing information may indicate a timing value of a downlink frame associated with the first UE 115-a. For instance, the second timing information may indicate a timing value of a start of a downlink frame (e.g., an anchor UE's downlink frame) plus the propagation delay associated with the first UE 115-a (e.g., the propagation delay experienced by the first UE 115-a or d_{A}). Communicating (e.g., receiving or transmitting) the first signal 245-a or the first signal 245-b in accordance with the timing may be based on the timing value of the downlink frame. For instance, the timing value of the downlink frame+d_{A} may be utilized to synchronize the first signal 245-b and the second signal 250.

In some examples, the second timing information may indicate a timing value of a start of a downlink frame (e.g., a downlink frame associated with the first UE 115-a or an anchor UE's downlink frame) plus a TA value associated with the first UE 115-a (e.g., TA1 or TA_{A}). Communicating (e.g., receiving or transmitting) the first signal 245-a or the first signal 245-b in accordance with the timing may be based on the timing value of the downlink frame. For instance, the timing value of the downlink frame+TA_{A} may be utilized to synchronize the first signal 245-b and the second signal 250. Examples of TA_{A} are provided with reference to FIG. 3 and FIG. 4.

In some examples, the second UE 115-b may determine a delay value (e.g., T_{Δ}) associated with the sidelink 235 between the first UE 115-a and the second UE 115-b. For instance, the first UE 115-a (e.g., an anchor UE) or the second UE 115-b (e.g., a companion UE) may negotiate or estimate the delay value (e.g., T_{Δ}) on the sidelink 235 (e.g., a 3GPP link or non-3GPP link). The delay value (e.g., T_{Δ}) may depend on one or more channel conditions, sidelink (e.g., cooperation link) type, congestion level, or a mobility of the first UE 115-a or the second UE 115-b (e.g., a user with XR wearables), among other examples.

In some approaches, the delay value (e.g., T_{Δ}) may be indicated via downlink signaling (e.g., second timing information) from the network entity 105-a to the second UE 115-b. For example, downlink signaling may be utilized to convey cross-UE information, the delay value may be estimated or negotiated between the first UE 115-a and the second UE 115-b, or a synchronization signal with one or more of the quantities described herein (e.g., a delay between downlink frames, a timing value of one or more downlink frames, d_{C}, d_{A}, one or more TA values, TA_{C}, TA_{A}, a delay value, or T_{Δ} among other examples) may be signaled to the second UE 115-b. For instance, the first UE 115-a may determine (e.g., estimate) the delay value (e.g., T_{Δ}), which may be indicated to the network entity 105-a, which may indicate the delay value to the second UE 115-b. Additionally, or alternatively, the network entity 105-a may determine (e.g., estimate) the delay value (e.g., T_{Δ}) and indicate the delay value to the second UE 115-b. For instance, the network entity 105-a may utilize a timestamp of a signal relayed from the first UE 115-a via the second UE 115-b to estimate a total delay from the first UE 115-a to the network entity 105-a via the second UE 115-b, and may subtract the propagation delay from the total delay to determine the delay value (e.g., T_{Δ}), which may be indicated to the second UE 115-b via downlink signaling. In some examples, the second UE 115-b may communicate (e.g., receive or transmit the first signal 245-a or the first signal 245-b by receiving the first signal 245-a via the sidelink 235 or transmitting the first signal 245-b based on the timing that is based on the second timing information and the delay value.

In some aspects, the first UE 115-a (e.g., an anchor UE) and the second UE 115-b (e.g., a companion UE) may be configured with one TA, where the first UE 115-a may transmit IQ samples to the second UE 115-b. In some examples, one UE (e.g., the first UE 115-a, a master UE of a set of UEs, among other examples) may determine (e.g., negotiate) a TA on behalf of the second UE 115-b. In some cases, two TAs may not be utilized (e.g., in cases other than multi-transmission and reception point (mTRP) scenarios).

To ensure synchronization between uplink transmissions of the first UE 115-a and the second UE 115-b, the first UE 115-a (e.g., an anchor UE) may negotiate a virtual TA value (e.g., a virtual TA_{C}) with the network (e.g., the network entity 105-a) for the second UE 115-b (e.g., a companion UE). The virtual TA value may be used as a reference to synchronize uplink transmissions (e.g., the first signal 245-b and the second signal 250) at the network (e.g., network entity 105-a).

In some examples, the timing information 225 indicates a TA value associated with the first UE 115-a (e.g., TA_{A}), a first timing value of a first downlink frame associated with the first UE 115-a (e.g., a receive (Rx) timing at an anchor UE), or a second timing value of a second downlink frame associated with the second UE 115-b (e.g., a Rx timing at a companion UE). The first UE 115-a may determine (e.g., estimate) the virtual TA value associated with the second UE 115-b based on the TA value, the first timing value of the first downlink frame associated with the first UE 115-a, and the second timing value of the second downlink frame associated with the second UE 115-b.

In some examples, the virtual TA value is based on a sum of the TA value and a difference between the second timing value and the first timing value. For instance, the first UE 115-a may determine the virtual TA_{C} value as: virtual TA_{C} value=TA_{A}+2*(Rx timing at companion UE-Rx timing at anchor UE). Transmitting or obtaining the first signal 245-a or the first signal 245-b may include transmitting the first signal 245-a via the sidelink 235 based on the timing that is based on the virtual TA value.

In some approaches, the virtual TA value may be determined (e.g., estimated or calculated) by the first UE 115-a (e.g., an anchor UE) and communicated to the second UE 115-b (e.g., a companion UE). The signaling of the virtual TA value may be performed via the sidelink (e.g., via a 3GPP sidelink, a non-3GPP sidelink, or through UE-UE communication). For instance, the first UE 115-a may transmit an indicator of the virtual TA value via the sidelink 235 associated with the second UE 115-b.

In some approaches, the virtual TA value may be determined (e.g., estimated or calculated) by the second UE 115-b (e.g., a companion UE) based on the TA associated with the first UE 115-a and the Rx timing at the second UE 115-b. For example, the first UE 115-a may transmit, via the sidelink 235, the TA value associated with the first UE 115-a, the first timing value of the first downlink frame associated with the first UE 115-a, or the second timing value of the second downlink frame associated with the second UE 115-b. Additionally, or alternatively, downlink signaling (e.g., the timing information 225 or second timing information via the communication link 125-b) may be utilized to communicate one or more values to determine the virtual TA value at the second UE 115-b.

For instance, the network entity 105-a may output, or the second UE 115-b may receive, the TA value associated with the first UE 115-a, the first timing value of the first downlink frame associated with the first UE 115-a, or the second timing value of the second downlink frame associated with the second UE 115-b.

The TA value associated with the first UE 115-a, the first timing value of the first downlink frame associated with the first UE 115-a, or the second timing value of the second downlink frame associated with the second UE 115-b may be utilized to determine the virtual TA value at the second UE 115-b.

In some examples, the first UE 115-a may transmit capability information indicating a capability of the first UE 115-a to synchronize a transmission from the first UE 115-a and a transmission from a second UE 115-b to the network entity 105-a. Receiving the timing information 225 may be based on the capability information. Additionally, or alternatively, the second UE 115-b may transmit capability information indicating a capability of the second UE 115-b to synchronize a transmission from the first UE 115-a and a transmission from a second UE 115-b to the network entity 105-a. Receiving the second timing information may be based on the capability information.

FIG. 3 shows an example of a timing diagram 300 that supports signaling for uplink synchronization with UEs in accordance with one or more aspects of the present disclosure. The timing diagram 300 illustrates a first frame timing 305 at a network entity (e.g., network entity 105-a), a second frame timing 310 at an anchor UE (e.g., first UE 115-a), and a third frame timing 315 at a companion UE (e.g., second UE 115-b). Downlink frames 320-a are transmitted from a network entity to arrive as downlink frames 320-b at the anchor UE and downlink frames 320-c at the companion UE. Specifically, FIG. 3 illustrates a scenario where a propagation delay d_{A} 360 for an anchor UE that is approximately equal to a propagation delay d_{C} 370 for a companion UE. Uplink frames 325-b may be transmitted from the anchor UE and uplink frames 325-c may be transmitted from the companion UE to arrive as uplink frames 325-a at the network entity.

As illustrated in FIG. 3, the anchor UE may transmit uplink frames 325-b with a timing advance TA_{A} 365 (relative to downlink frames 320-b) that is based on the propagation delay d_{A} 360 such that the uplink frames 325-a arrive in alignment with the downlink frames 320-a at the network entity. To synchronize the arrival times of the uplink frames 325-b of the anchor UE and the uplink frames 325-c of the companion UE, the anchor UE may receive timing information indicating the propagation delay d_{C} 370 or the timing advance TA_{C} 375 for the companion UE. For instance, the network entity may determine the propagation delay d_{C} 370 or the timing advance TA_{C} 375 for the companion UE (e.g., second UE 115-b), and may communicate the propagation delay d_{C} 370 or the timing advance TA_{C} 375 to the anchor UE (e.g., first UE 115-a) as described with reference to FIG. 2.

The anchor UE or the companion UE may determine a delay value T_{Δ} 355 associated with a sidelink as described with reference to FIG. 2. The anchor UE (e.g., the first UE 115-a) may transmit a first signal 350 (e.g., IQ samples) to the companion UE (e.g., the second UE 115-b) via the sidelink. For instance, the anchor UE may transmit the first signal 350 (e.g., the first signal 245-a) at a time 330, or with an advance timing 335 (e.g., with an IQ sample transmission delay dIQ_{A}), before transmitting the uplink frames 325-b (e.g., the second signal 250) to the network entity. As illustrated in FIG. 3, the first signal 350 is transmitted with a timing that is a combination of the timing advance TA_{C} 375 of the companion UE and the delay value T_{Δ} 355 associated with the sidelink or the advance timing 335. Transmitting the first signal 350 to the companion UE with the timing may allow the companion UE to transmit the uplink frames 325-c (e.g., the first signal 245-b) such that the uplink frames 325-c arrive in alignment with the downlink frames 320-a or in alignment with the uplink frames 325-b (e.g., the second signal 250) at the network entity. For instance, the anchor UE may transmit IQ samples early enough (e.g., in accordance with the propagation delay d_{C} 370, the timing advance TA_{C} 375, or the IQ sample transmission delay dIQ_{A}) to ensure that the companion UE receives the IQ samples by or before a time when an uplink frame 325-c begins.

FIG. 4 shows an example of a timing diagram 400 that supports signaling for uplink synchronization with UEs in accordance with one or more aspects of the present disclosure. The timing diagram 400 illustrates a first frame timing 405 at a network entity (e.g., network entity 105-a), a second frame timing 410 at an anchor UE (e.g., first UE 115-a), and a third frame timing 415 at a companion UE (e.g., second UE 115-b). Downlink frames 420-a are transmitted from a network entity to arrive as downlink frames 420-b at the anchor UE and downlink frames 420-c at the companion UE. Specifically, FIG. 4 illustrates a scenario where a propagation delay d_{A} 460 for an anchor UE that is less than a propagation delay d_{C} 470 for a companion UE (e.g., d_{C}>d_{A}). Uplink frames 425-b may be transmitted from the anchor UE and uplink frames 425-c may be transmitted from the companion UE to arrive as uplink frames 425-a at the network entity.

As illustrated in FIG. 4, the anchor UE may transmit uplink frames 425-b with a timing advance TA_{A} 465 (relative to downlink frames 420-b) that is based on the propagation delay d_{A} 460 such that the uplink frames 425-a arrive in alignment with the downlink frames 420-a at the network entity. To synchronize the arrival times of the uplink frames 425-b of the anchor UE and the uplink frames 425-c of the companion UE, the anchor UE may receive timing information indicating the propagation delay d_{C} 470 or the timing advance TA_{C} 475 for the companion UE. For instance, the network entity may determine the propagation delay d_{C} 470 or the timing advance TA_{C} 475 for the companion UE (e.g., second UE 115-b), and may communicate the propagation delay d_{C} 470 or the timing advance TA_{C} 475 to the anchor UE (e.g., first UE 115-a) as described with reference to FIG. 2.

The anchor UE or the companion UE may determine a delay value T_{Δ} 455 associated with a sidelink as described with reference to FIG. 2. The anchor UE (e.g., the first UE 115-a) may transmit a first signal 450 (e.g., IQ samples) to the companion UE (e.g., the second UE 115-b) via the sidelink. For instance, the anchor UE may transmit the first signal 450 (e.g., the first signal 245-a) at a time 430, or with an advance timing 435 (e.g., with an IQ sample transmission delay dIQ_{A}), before transmitting the uplink frames 425-b (e.g., the second signal 250) to the network entity. As illustrated in FIG. 4, the first signal 450 is transmitted with a timing that is a combination of the timing advance TA_{C} 475 of the companion UE and the delay value T_{Δ} 455 associated with the sidelink or the advance timing 435. Transmitting the first signal 450 to the companion UE with the timing may allow the companion UE to transmit the uplink frames 425-c (e.g., the first signal 245-b) such that the uplink frames 425-c arrive in alignment with the downlink frames 420-a or in alignment with the uplink frames 425-b (e.g., the second signal 250) at the network entity. For instance, the anchor UE may transmit IQ samples early enough (e.g., in accordance with the propagation delay d_{C} 470, the timing advance TA_{C} 475, or the IQ sample transmission delay dIQ_{A}) to ensure that the companion UE receives the IQ samples by or before a time when an uplink frame 425-c begins. The example of FIG. 4 illustrates a scenario where the anchor UE transmits the first signal 450 (e.g., IQ samples) earlier than the scenario described with reference to FIG. 3 due to an increase in the IQ sample transmission delay dIQ_{A}, which results in the companion UE beginning the transmission of the uplink frames 425-c before the anchor UE begins the transmission of the uplink frames 425-b.

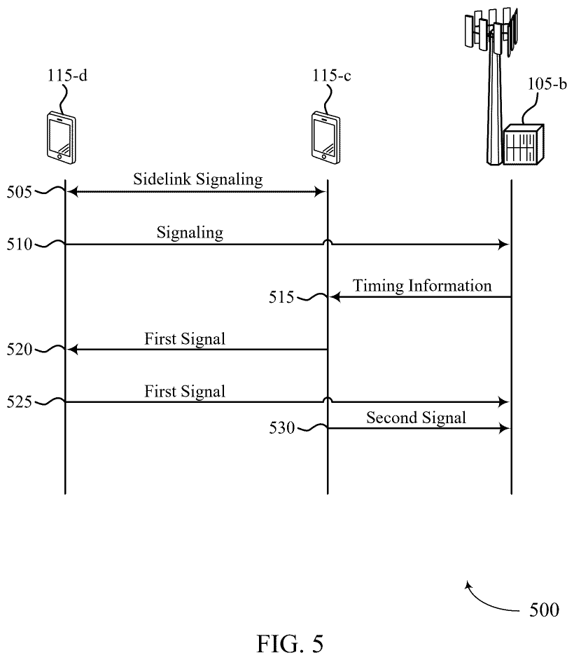

FIG. 5 shows an example of a process flow 500 that supports signaling for uplink synchronization with UEs in accordance with one or more aspects of the present disclosure. The process flow 500 may include a UE 115-c, a UE 115-d, and a network entity 105-b. The UE 115-c may be an example of a UE 115 as described with reference to FIG. 1, the first UE 115-a as described with reference to FIG. 2, or an anchor UE as described herein. The UE 115-d may be an example of a UE 115 as described with reference to FIG. 1, the second UE 115-b as described with reference to FIG. 2, a companion UE as described with reference to FIG. 3, or a companion UE as described with reference to FIG. 4. The network entity 105-b may be an example of a network entity 105 as described with reference to FIG. 1, a network entity 105-a as described with reference to FIG. 2, a network entity as described with reference to FIG. 3, or a network entity as described with reference to FIG. 4.

In the following description of the process flow 500, some examples of the operations between the network entity 105-b, the UE 115-c, and the UE 115-d may be transmitted in a different order than the example order shown, or the operations performed by the network entity 105-b, the UE 115-c, and the UE 115-d may be performed in different orders or at different times. In some examples, one or more operations may be omitted from the process flow 500, or one or more other operations may be added to the process flow 500. Further, although some operations or signaling may be shown to occur at different times for discussion purposes, these operations may actually occur at the same time or in overlapping time periods in some examples.

At 505, the UE 115-c and the UE 115-d may communicate signaling via a sidelink. For instance, the UE 115-c and the UE 115-d may transmit or receive data or control information via a sidelink, such as via the sidelink 235 described with reference to FIG. 2, a sidelink as described with reference to FIG. 3, or a sidelink as described with reference to FIG. 4. The UE 115-c or the UE 115-d may utilize the signaling to determine a delay value associated with the sidelink, such as a delay value (e.g., T_{Δ}) described with reference to FIG. 2, a delay value 355 as described with reference to FIG. 3, or a delay value 455 as described with reference to FIG. 4.

At 510, the UE 115-d may transmit signaling to the network entity 105-b. For instance, the UE 115-d may transmit signaling (e.g., data or control information), such as the signaling 240 described with reference to FIG. 2. The signaling may be transmitted via an uplink, such as via the communication link 125-b described with reference to FIG. 2. The network entity 105-b may utilize the signaling to determine timing information, such as the timing information 225 described with reference to FIG. 2, the propagation delay d_{A} 360 or the timing advance TA_{A} 365 as described with reference to FIG. 3, or the propagation delay d_{A} 460 or the timing advance TA_{A} 465 as described with reference to FIG. 4.

At 515, the network entity 105-b may output (e.g., transmit) the timing information to the UE 115-c. For instance, the UE 115-d may transmit the timing information, such as the timing information 225 described with reference to FIG. 2, the propagation delay d_{A} 360 or the timing advance TA_{A} 365 as described with reference to FIG. 3, or the propagation delay d_{A} 460 or the timing advance TA_{A} 465 as described with reference to FIG. 4. The signaling may be transmitted via downlink, such as via the communication link 125-a described with reference to FIG. 2.

At 520, the UE 115-c may transmit a first signal to the UE 115-d. For instance, the UE 115-c may transmit the first signal, such as the first signal 245-a described with reference to FIG. 2, the first signal 350 as described with reference to FIG. 3, or the first signal 450 as described with reference to FIG. 4. The signaling may be transmitted via the sidelink with a timing that is based on the timing information (e.g., timing information 225) as described with reference to FIG. 2, FIG. 3, or FIG. 4.

At 525, the UE 115-d may transmit a first signal to the network entity 105-b. For instance, the UE 115-c may transmit the first signal, such as the first signal 245-b described with reference to FIG. 2, the uplink frames 325-c as described with reference to FIG. 3, or the uplink frames 425-c as described with reference to FIG. 4. The first signal may be transmitted via an uplink, such as the communication link 125-b as described with reference to FIG. 2.

At 530, the UE 115-d may transmit a second signal to the network entity 105-b. For instance, the UE 115-c may transmit the second signal, such as the second signal 250 described with reference to FIG. 2, the uplink frames 325-b as described with reference to FIG. 3, or the uplink frames 425-b as described with reference to FIG. 4. The second signal may be transmitted via an uplink, such as the communication link 125-a as described with reference to FIG. 2. Due to the timing utilized to transmit the first signal, the first signal and the second signal may arrive in an approximately synchronized time at the network entity 105-b.

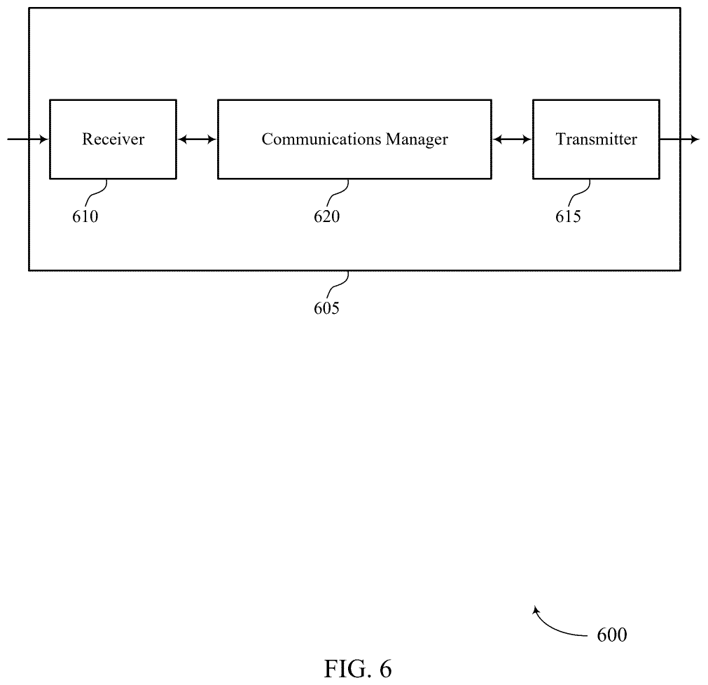

FIG. 6 shows a block diagram 600 of a device 605 that supports signaling for uplink synchronization with UEs in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling for uplink synchronization with UEs). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling for uplink synchronization with UEs). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of signaling for uplink synchronization with UEs as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving timing information via a downlink associated with a network entity, where the timing information is based on a propagation delay of signaling between a second UE and the network entity. The communications manager 620 is capable of, configured to, or operable to support a means for transmitting, in accordance with a timing that is based on the timing information, a first signal via a sidelink between the first UE and the second UE. The communications manager 620 is capable of, configured to, or operable to support a means for transmitting a second signal via an uplink associated with the network entity, where the second signal is associated with the first signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, or more efficient utilization of communication resources.

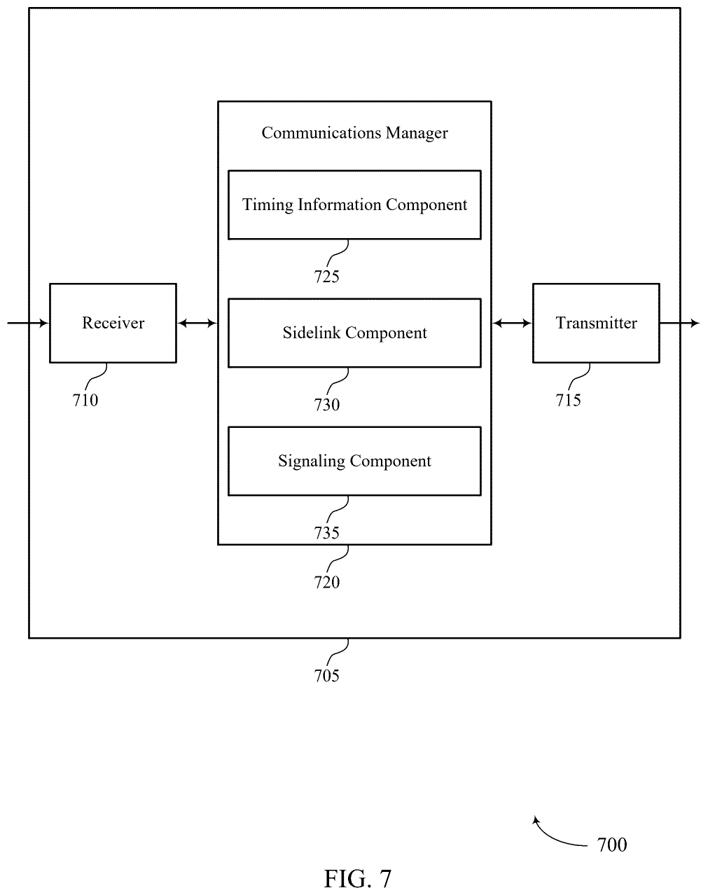

FIG. 7 shows a block diagram 700 of a device 705 that supports signaling for uplink synchronization with UEs in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to signaling for uplink synchronization with UEs). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to signaling for uplink synchronization with UEs). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of signaling for uplink synchronization with UEs as described herein. For example, the communications manager 720 may include a timing information component 725, a sidelink component 730, a signaling component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The timing information component 725 is capable of, configured to, or operable to support a means for receiving timing information via a downlink associated with a network entity, where the timing information is based on a propagation delay of signaling between a second UE and the network entity. The sidelink component 730 is capable of, configured to, or operable to support a means for transmitting, in accordance with a timing that is based on the timing information, a first signal via a sidelink between the first UE and the second UE. The signaling component 735 is capable of, configured to, or operable to support a means for transmitting a second signal via an uplink associated with the network entity, where the second signal is associated with the first signal.

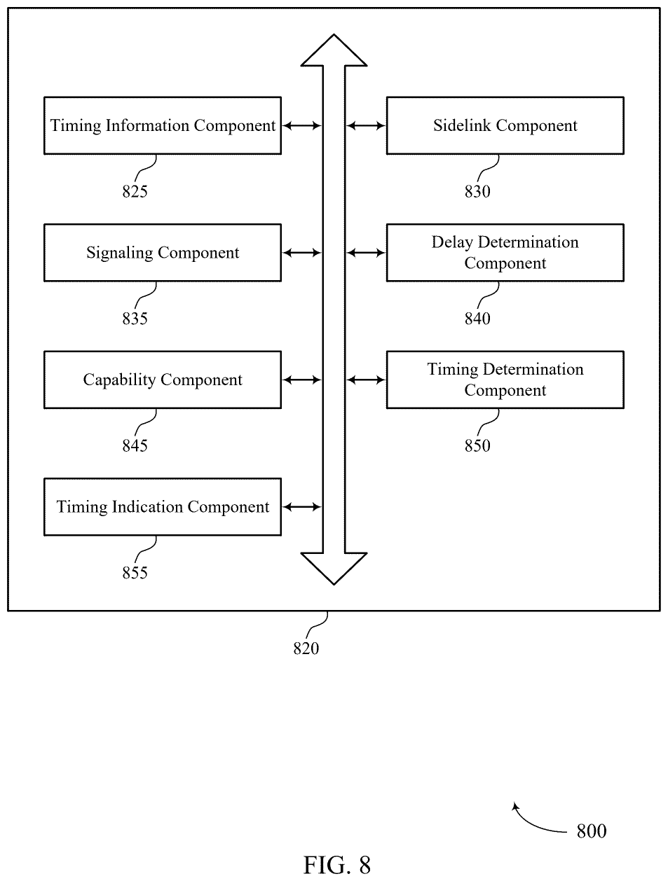

FIG. 8 shows a block diagram 800 of a communications manager 820 that supports signaling for uplink synchronization with UEs in accordance with one or more aspects of the present disclosure. The communications manager 820 may be an example of aspects of a communications manager 620, a communications manager 720, or both, as described herein. The communications manager 820, or various components thereof, may be an example of means for performing various aspects of signaling for uplink synchronization with UEs as described herein. For example, the communications manager 820 may include a timing information component 825, a sidelink component 830, a signaling component 835, a delay determination component 840, a capability component 845, a timing determination component 850, a timing indication component 855, or any combination thereof. Each of these components, or components or subcomponents thereof (e.g., one or more processors, one or more memories), may communicate, directly or indirectly, with one another (e.g., via one or more buses).

The timing information component 825 is capable of, configured to, or operable to support a means for receiving timing information via a downlink associated with a network entity, where the timing information is based on a propagation delay of signaling between a second UE and the network entity. The sidelink component 830 is capable of, configured to, or operable to support a means for transmitting, in accordance with a timing that is based on the timing information, a first signal via a sidelink between the first UE and the second UE. The signaling component 835 is capable of, configured to, or operable to support a means for transmitting a second signal via an uplink associated with the network entity, where the second signal is associated with the first signal.

In some examples, the timing information indicates a TA value associated with the second UE. In some examples, transmitting the first signal in accordance with the timing is based on the TA value associated with the second UE.

In some examples, the timing information indicates a delay between a first downlink frame associated with the first UE and a second downlink frame associated with the second UE. In some examples, transmitting the first signal in accordance with the timing is based on the delay between the first downlink frame and the second downlink frame.

In some examples, the timing information indicates a timing value of a downlink frame associated with the second UE. In some examples, transmitting the first signal in accordance with the timing is based on the timing value of the downlink frame.

In some examples, the delay determination component 840 is capable of, configured to, or operable to support a means for determining a delay value associated with the sidelink between the first UE and the second UE, where transmitting the first signal includes transmitting the first signal via the sidelink based on the timing that is based on the timing information and the delay value.

In some examples, the timing information indicates a first TA value associated with the first UE and a second TA value associated with the second UE. In some examples, transmitting the first signal in accordance with the timing via the sidelink is based on the second TA value. In some examples, transmitting the second signal via the uplink is based on the first TA value.

In some examples, the timing information indicates a TA value associated with the first UE, a first timing value of a first downlink frame associated with the first UE, or a second timing value of a second downlink frame associated with the second UE.

In some examples, the timing determination component 850 is capable of, configured to, or operable to support a means for determining a virtual TA value associated with the second UE based on the TA value, the first timing value of the first downlink frame associated with the first UE, and the second timing value of the second downlink frame associated with the second UE, where transmitting the first signal includes transmitting the first signal via the sidelink based on the timing that is based on the virtual TA value.

In some examples, the timing indication component 855 is capable of, configured to, or operable to support a means for transmitting an indicator of the virtual TA value via the sidelink associated with the second UE.

In some examples, the virtual TA value is based on a sum of the TA value and a difference between the second timing value and the first timing value.

In some examples, the sidelink component 830 is capable of, configured to, or operable to support a means for transmitting, via the sidelink, the TA value associated with the first UE, the first timing value of the first downlink frame associated with the first UE, or the second timing value of the second downlink frame associated with the second UE.

In some examples, the capability component 845 is capable of, configured to, or operable to support a means for transmitting capability information indicating a capability of the first UE to synchronize a transmission from the first UE and a transmission from a second UE to the network entity, where receiving the timing information is based on the capability information.

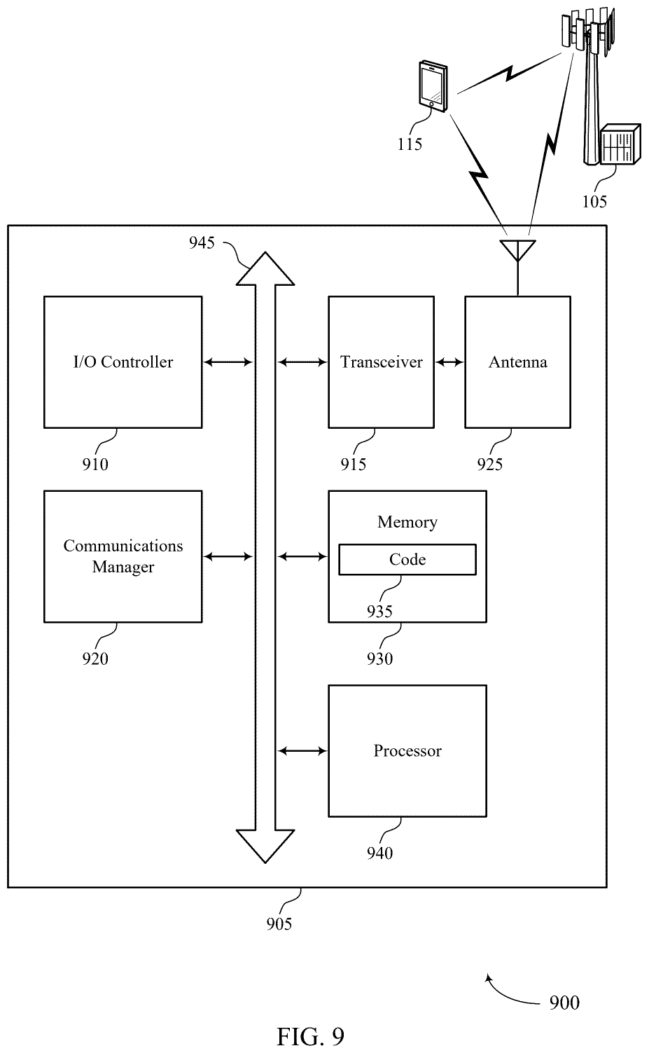

FIG. 9 shows a diagram of a system 900 including a device 905 that supports signaling for uplink synchronization with UEs in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting signaling for uplink synchronization with UEs). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

For example, the communications manager 920 is capable of, configured to, or operable to support a means for receiving timing information via a downlink associated with a network entity, where the timing information is based on a propagation delay of signaling between a second UE and the network entity. The communications manager 920 is capable of, configured to, or operable to support a means for transmitting, in accordance with a timing that is based on the timing information, a first signal via a sidelink between the first UE and the second UE. The communications manager 920 is capable of, configured to, or operable to support a means for transmitting a second signal via an uplink associated with the network entity, where the second signal is associated with the first signal.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of signaling for uplink synchronization with UEs as described herein, or the at least one processor 940 and the at least one memory 930 may be otherwise configured to, individually or collectively, perform or support such operations.

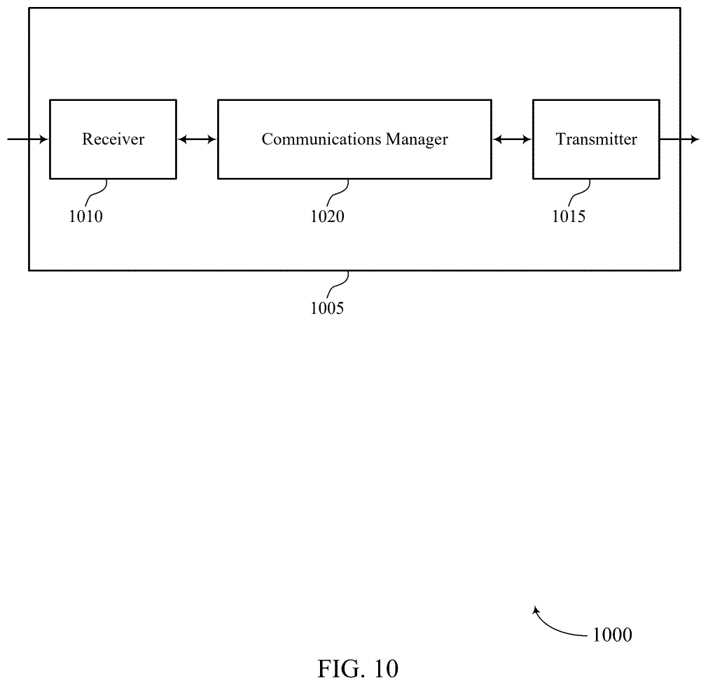

FIG. 10 shows a block diagram 1000 of a device 1005 that supports signaling for uplink synchronization with UEs in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of signaling for uplink synchronization with UEs as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for obtaining signaling from a second UE via an uplink, where the second UE and a first UE are associated via a sidelink. The communications manager 1020 is capable of, configured to, or operable to support a means for outputting timing information via a downlink associated with the first UE, where the timing information is based on a propagation delay of the signaling. The communications manager 1020 is capable of, configured to, or operable to support a means for obtaining, in accordance with a timing that is based on the timing information, a first signal associated with the second UE via the uplink. The communications manager 1020 is capable of, configured to, or operable to support a means for obtaining a second signal associated with the first UE via the uplink, where the second signal is associated with the first signal.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, or more efficient utilization of communication resources.

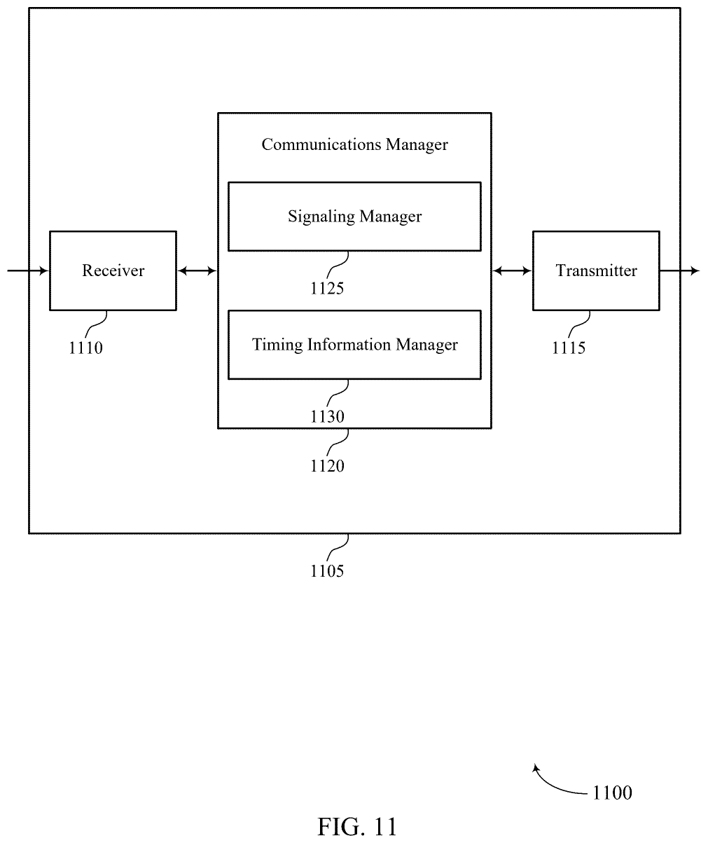

FIG. 11 shows a block diagram 1100 of a device 1105 that supports signaling for uplink synchronization with UEs in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of signaling for uplink synchronization with UEs as described herein. For example, the communications manager 1120 may include a signaling manager 1125 a timing information manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The signaling manager 1125 is capable of, configured to, or operable to support a means for obtaining signaling from a second UE via an uplink, where the second UE and a first UE are associated via a sidelink. The timing information manager 1130 is capable of, configured to, or operable to support a means for outputting timing information via a downlink associated with the first UE, where the timing information is based on a propagation delay of the signaling. The signaling manager 1125 is capable of, configured to, or operable to support a means for obtaining, in accordance with a timing that is based on the timing information, a first signal associated with the second UE via the uplink. The signaling manager 1125 is capable of, configured to, or operable to support a means for obtaining a second signal associated with the first UE via the uplink, where the second signal is associated with the first signal.

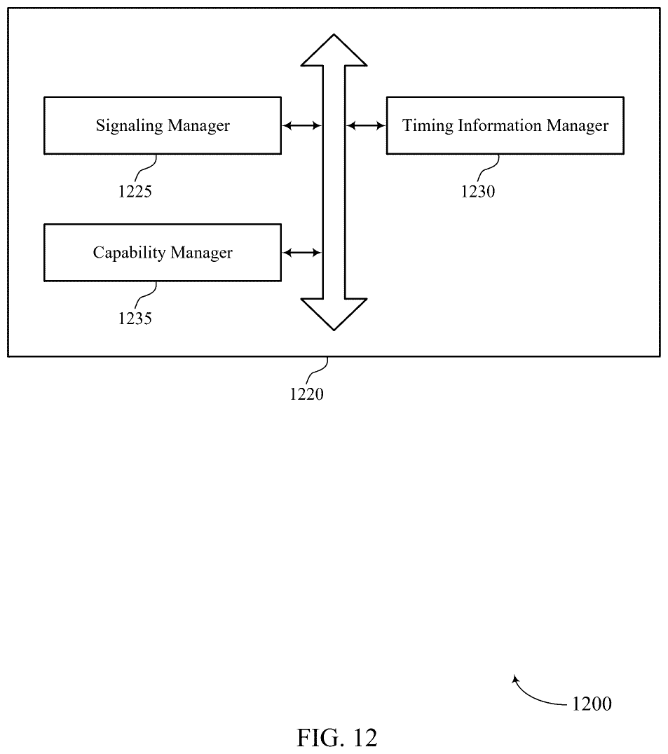

FIG. 12 shows a block diagram 1200 of a communications manager 1220 that supports signaling for uplink synchronization with UEs in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of signaling for uplink synchronization with UEs as described herein. For example, the communications manager 1220 may include a signaling manager 1225, a timing information manager 1230, a capability manager 1235, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The signaling manager 1225 is capable of, configured to, or operable to support a means for obtaining signaling from a second UE via an uplink, where the second UE and a first UE are associated via a sidelink. The timing information manager 1230 is capable of, configured to, or operable to support a means for outputting timing information via a downlink associated with the first UE, where the timing information is based on a propagation delay of the signaling. In some examples, the signaling manager 1225 is capable of, configured to, or operable to support a means for obtaining, in accordance with a timing that is based on the timing information, a first signal associated with the second UE via the uplink. In some examples, the signaling manager 1225 is capable of, configured to, or operable to support a means for obtaining a second signal associated with the first UE via the uplink, where the second signal is associated with the first signal.

In some examples, the timing information indicates a TA value associated with the second UE. In some examples, obtaining the first signal in accordance with the timing is based on the TA value associated with the second UE.

In some examples, the timing information indicates a delay between a first downlink frame associated with the first UE and a second downlink frame associated with the second UE. In some examples, obtaining the first signal in accordance with the timing is based on the delay between the first downlink frame and the second downlink frame.

In some examples, the timing information indicates a timing value of a downlink frame associated with the second UE. In some examples, obtaining the first signal in accordance with the timing is based on the timing of the downlink frame.

In some examples, the timing information indicates a first TA value associated with the first UE and a second TA value associated with the second UE. In some examples, obtaining the first signal in accordance with the timing via the uplink is based on the second TA value. In some examples, obtaining the second signal via the uplink is based on the first TA value.

In some examples, the timing information indicates a TA value associated with the first UE, a first timing value of a first downlink frame associated with the first UE, or a second timing value of a second downlink frame associated with the second UE.

In some examples, the capability manager 1235 is capable of, configured to, or operable to support a means for obtaining capability information indicating a capability of the first UE to synchronize a transmission from the first UE and a transmission from a second UE to the network entity, where outputting the timing information is based on the capability information.

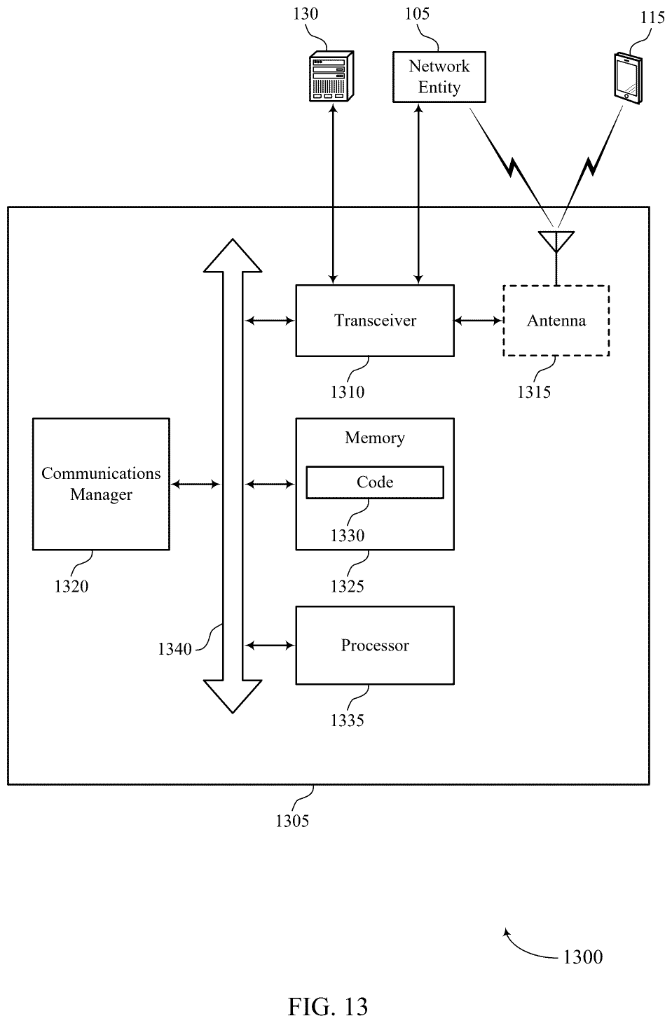

FIG. 13 shows a diagram of a system 1300 including a device 1305 that supports signaling for uplink synchronization with UEs in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting signaling for uplink synchronization with UEs). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

For example, the communications manager 1320 is capable of, configured to, or operable to support a means for obtaining signaling from a second UE via an uplink, where the second UE and a first UE are associated via a sidelink. The communications manager 1320 is capable of, configured to, or operable to support a means for outputting timing information via a downlink associated with the first UE, where the timing information is based on a propagation delay of the signaling. The communications manager 1320 is capable of, configured to, or operable to support a means for obtaining, in accordance with a timing that is based on the timing information, a first signal associated with the second UE via the uplink. The communications manager 1320 is capable of, configured to, or operable to support a means for obtaining a second signal associated with the first UE via the uplink, where the second signal is associated with the first signal.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of signaling for uplink synchronization with UEs as described herein, or the at least one processor 1335 and the at least one memory 1325 may be otherwise configured to, individually or collectively, perform or support such operations.

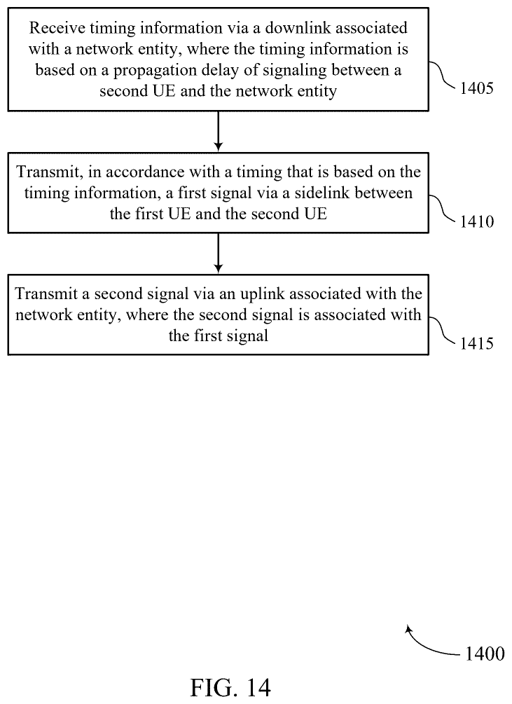

FIG. 14 shows a flowchart illustrating a method 1400 that supports signaling for uplink synchronization with UEs in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving timing information via a downlink associated with a network entity, where the timing information is based on a propagation delay of signaling between a second UE and the network entity. The operations of 1405 may be performed in accordance with examples as disclosed herein. In some examples, aspects of the operations of 1405 may be performed by a timing information component 825 as described with reference to FIG. 8.

At 1410, the method may include transmitting, in accordance with a timing that is based on the timing information, a first signal via a sidelink between the first UE and the second UE. The operations of 1410 may be performed in accordance with examples as disclosed herein. In some examples, aspects of the operations of 1410 may be performed by a sidelink component 830 as described with reference to FIG. 8.

At 1415, the method may include transmitting a second signal via an uplink associated with the network entity, where the second signal is associated with the first signal. The operations of 1415 may be performed in accordance with examples as disclosed herein. In some examples, aspects of the operations of 1415 may be performed by a signaling component 835 as described with reference to FIG. 8.

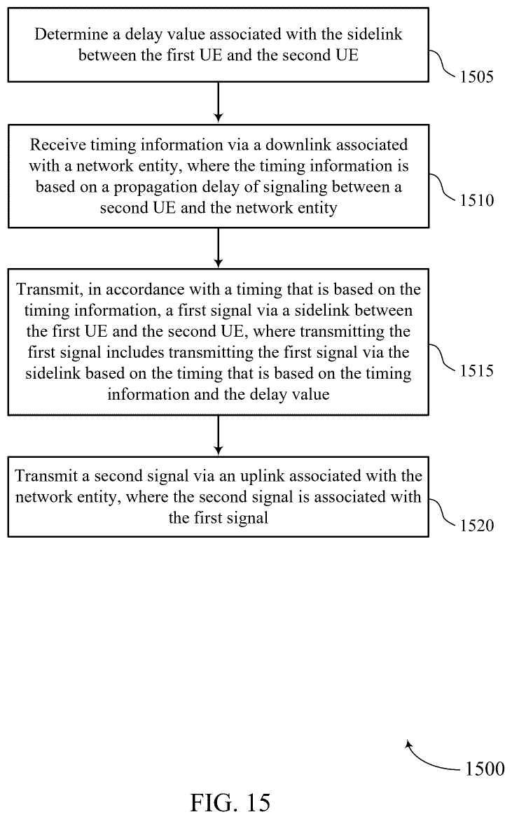

FIG. 15 shows a flowchart illustrating a method 1500 that supports signaling for uplink synchronization with UEs in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include determining a delay value associated with the sidelink between the first UE and the second UE. The operations of 1505 may be performed in accordance with examples as disclosed herein. In some examples, aspects of the operations of 1505 may be performed by a delay determination component 840 as described with reference to FIG. 8.

At 1510, the method may include receiving timing information via a downlink associated with a network entity, where the timing information is based on a propagation delay of signaling between a second UE and the network entity. The operations of 1510 may be performed in accordance with examples as disclosed herein. In some examples, aspects of the operations of 1510 may be performed by a timing information component 825 as described with reference to FIG. 8.

At 1515, the method may include transmitting, in accordance with a timing that is based on the timing information, a first signal via a sidelink between the first UE and the second UE, where transmitting the first signal includes transmitting the first signal via the sidelink based on the timing that is based on the timing information and the delay value. The operations of 1515 may be performed in accordance with examples as disclosed herein. In some examples, aspects of the operations of 1515 may be performed by a sidelink component 830 as described with reference to FIG. 8.

At 1520, the method may include transmitting a second signal via an uplink associated with the network entity, where the second signal is associated with the first signal. The operations of 1520 may be performed in accordance with examples as disclosed herein. In some examples, aspects of the operations of 1520 may be performed by a signaling component 835 as described with reference to FIG. 8.

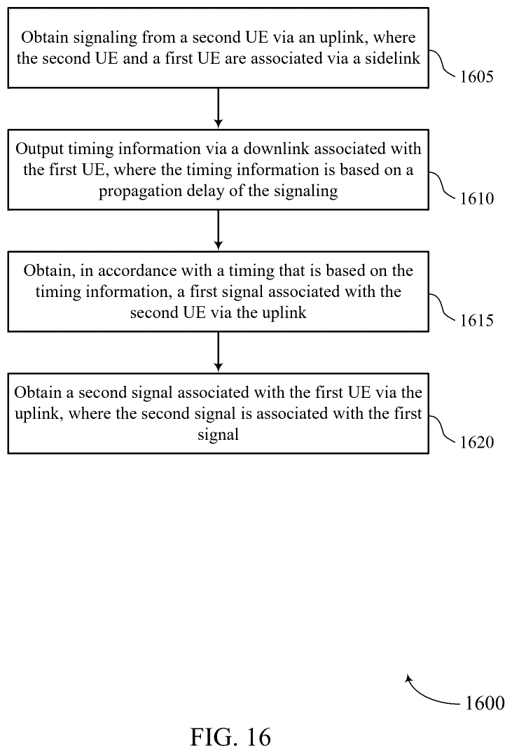

FIG. 16 shows a flowchart illustrating a method 1600 that supports signaling for uplink synchronization with UEs in accordance with one or more aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include obtaining signaling from a second UE via an uplink, where the second UE and a first UE are associated via a sidelink. The operations of 1605 may be performed in accordance with examples as disclosed herein. In some examples, aspects of the operations of 1605 may be performed by a signaling manager 1225 as described with reference to FIG. 12.

At 1610, the method may include outputting timing information via a downlink associated with the first UE, where the timing information is based on a propagation delay of the signaling. The operations of 1610 may be performed in accordance with examples as disclosed herein. In some examples, aspects of the operations of 1610 may be performed by a timing information manager 1230 as described with reference to FIG. 12.

At 1615, the method may include obtaining, in accordance with a timing that is based on the timing information, a first signal associated with the second UE via the uplink. The operations of 1615 may be performed in accordance with examples as disclosed herein. In some examples, aspects of the operations of 1615 may be performed by a signaling manager 1225 as described with reference to FIG. 12.

At 1620, the method may include obtaining a second signal associated with the first UE via the uplink, where the second signal is associated with the first signal. The operations of 1620 may be performed in accordance with examples as disclosed herein. In some examples, aspects of the operations of 1620 may be performed by a signaling manager 1225 as described with reference to FIG. 12.

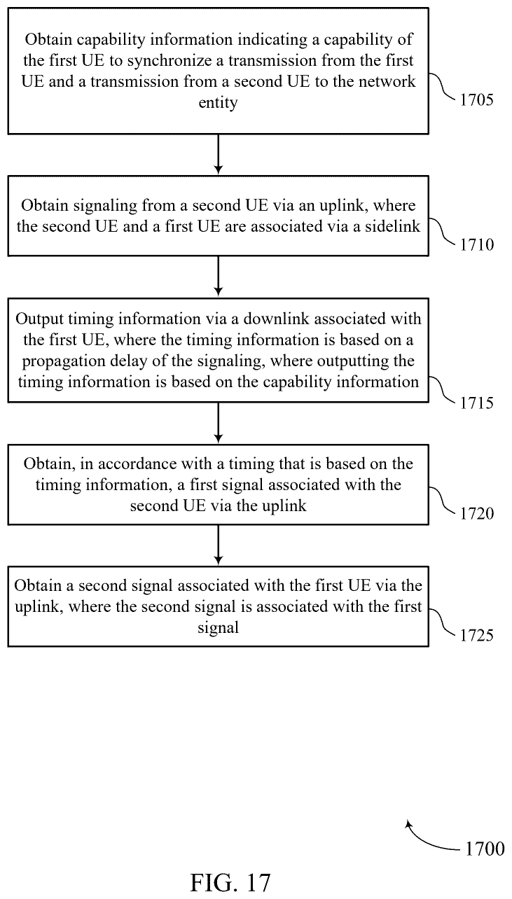

FIG. 17 shows a flowchart illustrating a method 1700 that supports signaling for uplink synchronization with UEs in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include obtaining capability information indicating a capability of the first UE to synchronize a transmission from the first UE and a transmission from a second UE to the network entity. The operations of 1705 may be performed in accordance with examples as disclosed herein. In some examples, aspects of the operations of 1705 may be performed by a capability manager 1235 as described with reference to FIG. 12.

At 1710, the method may include obtaining signaling from a second UE via an uplink, where the second UE and a first UE are associated via a sidelink. The operations of 1710 may be performed in accordance with examples as disclosed herein. In some examples, aspects of the operations of 1710 may be performed by a signaling manager 1225 as described with reference to FIG. 12.

At 1715, the method may include outputting timing information via a downlink associated with the first UE, where the timing information is based on a propagation delay of the signaling, where outputting the timing information is based on the capability information. The operations of 1715 may be performed in accordance with examples as disclosed herein. In some examples, aspects of the operations of 1715 may be performed by a timing information manager 1230 as described with reference to FIG. 12.

At 1720, the method may include obtaining, in accordance with a timing that is based on the timing information, a first signal associated with the second UE via the uplink. The operations of 1720 may be performed in accordance with examples as disclosed herein. In some examples, aspects of the operations of 1720 may be performed by a signaling manager 1225 as described with reference to FIG. 12.

At 1725, the method may include obtaining a second signal associated with the first UE via the uplink, where the second signal is associated with the first signal. The operations of 1725 may be performed in accordance with examples as disclosed herein. In some examples, aspects of the operations of 1725 may be performed by a signaling manager 1225 as described with reference to FIG. 12.

The following provides an overview of aspects of the present disclosure:

Aspect 1: A method for wireless communications at a first UE, comprising: receiving timing information via a downlink associated with a network entity, wherein the timing information is based at least in part on a propagation delay of signaling between a second UE and the network entity; transmitting, in accordance with a timing that is based at least in part on the timing information, a first signal via a sidelink between the first UE and the second UE; and transmitting a second signal via an uplink associated with the network entity, wherein the second signal is associated with the first signal.

Aspect 2: The method of aspect 1, wherein the timing information indicates a TA value associated with the second UE, and transmitting the first signal in accordance with the timing is based at least in part on the TA value associated with the second UE.

Aspect 3: The method of aspect 1, wherein the timing information indicates a delay between a first downlink frame associated with the first UE and a second downlink frame associated with the second UE, and transmitting the first signal in accordance with the timing is based at least in part on the delay between the first downlink frame and the second downlink frame.

Aspect 4: The method of aspect 1, wherein the timing information indicates a timing value of a downlink frame associated with the second UE, and transmitting the first signal in accordance with the timing is based at least in part on the timing value of the downlink frame.

Aspect 5: The method of any of aspects 1 through 4, further comprising: determining a delay value associated with the sidelink between the first UE and the second UE, wherein transmitting the first signal comprises transmitting the first signal via the sidelink based at least in part on the timing that is based at least in part on the timing information and the delay value.

Aspect 6: The method of any of aspects 1 through 2, wherein the timing information indicates a first TA value associated with the first UE and a second TA value associated with the second UE, and transmitting the first signal in accordance with the timing via the sidelink is based at least in part on the second TA value, and transmitting the second signal via the uplink is based at least in part on the first TA value.

Aspect 7: The method of aspect 1, wherein the timing information indicates a TA value associated with the first UE, a first timing value of a first downlink frame associated with the first UE, or a second timing value of a second downlink frame associated with the second UE.

Aspect 8: The method of aspect 7, further comprising: determining a virtual TA value associated with the second UE based at least in part on the TA value, the first timing value of the first downlink frame associated with the first UE, and the second timing value of the second downlink frame associated with the second UE, wherein transmitting the first signal comprises transmitting the first signal via the sidelink based at least in part on the timing that is based at least in part on the virtual TA value.

Aspect 9: The method of aspect 8, further comprising: transmitting an indicator of the virtual TA value via the sidelink associated with the second UE.

Aspect 10: The method of any of aspects 8 through 9, wherein the virtual TA value is based at least in part on a sum of the TA value and a difference between the second timing value and the first timing value.

Aspect 11: The method of any of aspects 7 through 10, further comprising: transmitting, via the sidelink, the TA value associated with the first UE, the first timing value of the first downlink frame associated with the first UE, or the second timing value of the second downlink frame associated with the second UE.

Aspect 12: The method of any of aspects 1 through 11, further comprising: transmitting capability information indicating a capability of the first UE to synchronize a transmission from the first UE and a transmission from a second UE to the network entity, wherein receiving the timing information is based at least in part on the capability information.

Aspect 13: A method for wireless communications at a network entity, comprising: obtaining signaling from a second UE via an uplink, wherein the second UE and a first UE are associated via a sidelink; outputting timing information via a downlink associated with the first UE, wherein the timing information is based at least in part on a propagation delay of the signaling; obtaining, in accordance with a timing that is based at least in part on the timing information, a first signal associated with the second UE via the uplink; and obtaining a second signal associated with the first UE via the uplink, wherein the second signal is associated with the first signal.

Aspect 14: The method of aspect 13, wherein the timing information indicates a TA value associated with the second UE, and obtaining the first signal in accordance with the timing is based at least in part on the TA value associated with the second UE.

Aspect 15: The method of aspect 13, wherein the timing information indicates a delay between a first downlink frame associated with the first UE and a second downlink frame associated with the second UE, and obtaining the first signal in accordance with the timing is based at least in part on the delay between the first downlink frame and the second downlink frame.

Aspect 16: The method of aspect 13, wherein the timing information indicates a timing value of a downlink frame associated with the second UE, and obtaining the first signal in accordance with the timing is based at least in part on the timing of the downlink frame.

Aspect 17: The method of any of aspects 13 through 14, wherein the timing information indicates a first TA value associated with the first UE and a second TA value associated with the second UE, and obtaining the first signal in accordance with the timing via the uplink is based at least in part on the second TA value, and obtaining the second signal via the uplink is based at least in part on the first TA value.

Aspect 18: The method of aspect 13, wherein the timing information indicates a TA value associated with the first UE, a first timing value of a first downlink frame associated with the first UE, or a second timing value of a second downlink frame associated with the second UE.

Aspect 19: The method of any of aspects 13 through 18, further comprising: obtaining capability information indicating a capability of the first UE to synchronize a transmission from the first UE and a transmission from a second UE to the network entity, wherein outputting the timing information is based at least in part on the capability information.

Aspect 20: A first UE comprising one or more processors, one or more memories coupled with the one or more processors, and one or more processor-readable instructions stored in the one or more memories and executable by the one or more processors individually or collectively operable to cause the first UE to perform a method of any of aspects 1 through 12.

Aspect 21: A first UE comprising at least one means for performing a method of any of aspects 1 through 12.

Aspect 22: A non-transitory computer-readable medium storing code the code comprising instructions executable by one or more processors to perform a method of any of aspects 1 through 12.

Aspect 23: A network entity comprising one or more processors, one or more memories coupled with the one or more processors, and one or more processor-readable instructions stored in the one or more memories and executable by the one or more processors individually or collectively operable to cause the network entity to perform a method of any of aspects 13 through 19.

Aspect 24: A network entity comprising at least one means for performing a method of any of aspects 13 through 19.

Aspect 25: A non-transitory computer-readable medium storing code the code comprising instructions executable by one or more processors to perform a method of any of aspects 13 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first user equipment (UE), comprising:
one or more processors;
one or more memories coupled with the one or more processors; and
one or more processor-readable instructions stored in the one or more memories and executable by the one or more processors individually or collectively operable to cause the first UE to:
receive timing information via a downlink associated with a network entity, wherein the timing information is based at least in part on a propagation delay of signaling between a second UE and the network entity;
transmit, in accordance with a timing that is based at least in part on the timing information, a first signal via a sidelink between the first UE and the second UE; and
transmit a second signal via an uplink associated with the network entity, wherein the second signal is associated with the first signal.

2. The first UE of claim 1, wherein:
the timing information indicates a timing advance value associated with the second UE, and
transmitting the first signal in accordance with the timing is based at least in part on the timing advance value associated with the second UE.

3. The first UE of claim 1, wherein:
the timing information indicates a delay between a first downlink frame associated with the first UE and a second downlink frame associated with the second UE, and
transmitting the first signal in accordance with the timing is based at least in part on the delay between the first downlink frame and the second downlink frame.

4. The first UE of claim 1, wherein:
the timing information indicates a timing value of a downlink frame associated with the second UE, and
transmitting the first signal in accordance with the timing is based at least in part on the timing value of the downlink frame.

5. The first UE of claim 1, wherein the one or more processor-readable instructions are further executable by the one or more processors individually or collectively to cause the first UE to:
determine a delay value associated with the sidelink between the first UE and the second UE, wherein transmitting the first signal comprises transmitting the first signal via the sidelink based at least in part on the timing that is based at least in part on the timing information and the delay value.

6. The first UE of claim 1, wherein:
the timing information indicates a first timing advance value associated with the first UE and a second timing advance value associated with the second UE,
transmitting the first signal in accordance with the timing via the sidelink is based at least in part on the second timing advance value, and
transmitting the second signal via the uplink is based at least in part on the first timing advance value.

7. The first UE of claim 1, wherein the timing information indicates a timing advance value associated with the first UE, a first timing value of a first downlink frame associated with the first UE, or a second timing value of a second downlink frame associated with the second UE.

8. The first UE of claim 7, wherein the one or more processor-readable instructions are further executable by the one or more processors individually or collectively to cause the first UE to:
determine a virtual timing advance value associated with the second UE based at least in part on the timing advance value, the first timing value of the first downlink frame associated with the first UE, and the second timing value of the second downlink frame associated with the second UE, wherein transmitting the first signal comprises transmitting the first signal via the sidelink based at least in part on the timing that is based at least in part on the virtual timing advance value.

9. The first UE of claim 8, wherein the one or more processor-readable instructions are further executable by the one or more processors individually or collectively to cause the first UE to:
transmit an indicator of the virtual timing advance value via the sidelink associated with the second UE.

10. The first UE of claim 8, wherein the virtual timing advance value is based at least in part on a sum of the timing advance value and a difference between the second timing value and the first timing value.

11. The first UE of claim 7, wherein the one or more processor-readable instructions are further executable by the one or more processors individually or collectively to cause the first UE to:
transmit, via the sidelink, the timing advance value associated with the first UE, the first timing value of the first downlink frame associated with the first UE, or the second timing value of the second downlink frame associated with the second UE.

12. The first UE of claim 1, wherein the one or more processor-readable instructions are further executable by the one or more processors individually or collectively to cause the first UE to:
transmit capability information indicating a capability of the first UE to synchronize a transmission from the first UE and a transmission from the second UE to the network entity, wherein receiving the timing information is based at least in part on the capability information.

13. A network entity, comprising:
one or more processors;
one or more memories coupled with the one or more processors; and
one or more processor-readable instructions stored in the one or more memories and executable by the one or more processors individually or collectively operable to cause the network entity to:
obtain signaling from a second user equipment (UE) via an uplink, wherein the second UE and a first UE are associated via a sidelink;
output timing information via a downlink associated with the first UE, wherein the timing information is based at least in part on a propagation delay of the signaling;
obtain, in accordance with a timing that is based at least in part on the timing information, a first signal associated with the second UE via the uplink; and
obtain a second signal associated with the first UE via the uplink, wherein the second signal is associated with the first signal.

14. The network entity of claim 13, wherein:
the timing information indicates a timing advance value associated with the second UE, and
obtaining the first signal in accordance with the timing is based at least in part on the timing advance value associated with the second UE.

15. The network entity of claim 13, wherein:
the timing information indicates a delay between a first downlink frame associated with the first UE and a second downlink frame associated with the second UE, and
obtaining the first signal in accordance with the timing is based at least in part on the delay between the first downlink frame and the second downlink frame.

16. The network entity of claim 13, wherein:
the timing information indicates a timing value of a downlink frame associated with the second UE, and
obtaining the first signal in accordance with the timing is based at least in part on the timing of the downlink frame.

17. The network entity of claim 13, wherein:
the timing information indicates a first timing advance value associated with the first UE and a second timing advance value associated with the second UE,
obtaining the first signal in accordance with the timing via the uplink is based at least in part on the second timing advance value, and
obtaining the second signal via the uplink is based at least in part on the first timing advance value.

18. The network entity of claim 13, wherein the timing information indicates a timing advance value associated with the first UE, a first timing value of a first downlink frame associated with the first UE, or a second timing value of a second downlink frame associated with the second UE.

19. The network entity of claim 13, wherein the one or more processor-readable instructions are further executable by the one or more processors individually or collectively to cause the network entity to:
obtain capability information indicating a capability of the first UE to synchronize a transmission from the first UE and a transmission from the second UE to the network entity, wherein outputting the timing information is based at least in part on the capability information.

20. A method for wireless communications at a first user equipment (UE), comprising:
receiving timing information via a downlink associated with a network entity, wherein the timing information is based at least in part on a propagation delay of signaling between a second UE and the network entity;
transmitting, in accordance with a timing that is based at least in part on the timing information, a first signal via a sidelink between the first UE and the second UE; and
transmitting a second signal via an uplink associated with the network entity, wherein the second signal is associated with the first signal.
